(19) United States
(12) Patent Application Publication
(10) Pub. No.: US 2009/0287144 A1
(43) Pub. Date: Nov. 19, 2009

(54) PEDIATRIC MEDICINE DOSAGE CUP, TRAY, AND FABRICATION METHOD

(75) Inventors: Jill Malkin, New York, NY (US); Geoffrey J. Addeo, New York, NY (US)

Correspondence Address: DAVIS WRIGHT TREMAINE, LLP/Seattle, 1201 Third Avenue, Suite 2200, SEATTLE, WA, 98101-3045, US

(73) Assignee: KIDKUPZ LLC, New York, NY (US)

(21) Appl. No.: 12/390,352

(22) Filed: Feb. 20, 2009

Related U.S. Application Data
(63) Continuation-in-part of application No. 12/070,144, filed on Feb. 14, 2008.
(60) Provisional application No. 60/901,925, filed on Feb. 15, 2007.
(60) Provisional application No. 60/923,428, filed on Apr. 13, 2007.

(51) Int. Cl. A61J 7/00; B65D 21/036; B65D 21/032

(52) U.S. Cl. 604/78; 206/508; 206/509

(57) ABSTRACT

A cup having a rim and candy coating disposed about the rim. The coating has a flavored layer applied to the rim as a liquid having an acid component, sugar, and flavoring, and a sugar crystal layer applied to the flavored layer before it hardens. The cup may include a projection extending radially into the cup's interior. The projection includes a support surface for supporting a portion of a like cup inserted into the cup's interior and determining a depth of insertion of the like cup into the cup. The cup may include a plurality of spaced apart spacer projections extending radially into the interior of the cup, abutting the sidewall of the like cup inserted into the cup's interior, and thereby spacing the coating of the cup from the sidewall of the like cup. A method of and device for manufacturing the cup are also provided.

### CROSS REFERENCE TO RELATED APPLICATION(S)

This application is a continuation-in-part of U.S. patent application Ser. No. 12/070,144, filed Feb. 14, 2008, which claims the benefit of both U.S. Provisional Patent Application Ser. No. 60/901,925, filed Feb. 15, 2007 and U.S. Provisional Patent Application Ser. No. 60/923,428, filed Apr. 13, 2007.

### BACKGROUND OF THE INVENTION

1. Field of the Invention

The present invention relates to cups having a candy coating about their rims.

2. Description of the Related Art

Any person involved in childcare or a medical profession involving children knows getting children to take oral medications can be difficult because many oral medications have undesirable flavor components. For example, many medications include a bitter component children dislike. Some manufactures of such mediations have added sugar and other flavorings in an attempt to mask these undesirable flavor components. However, the result is often an over sweetened medication that retains a flavor disfavored by children. Therefore, a need exists in the art for devices that make oral medications more palatable to children. A further need exists for a device capable of masking undesirable flavor components in medications. The present application provides these and other advantages as will be apparent from the following detailed description and accompanying figures.

### BRIEF DESCRIPTION OF THE SEVERAL VIEWS OF THE DRAWING(S)

FIG. 1 is a perspective view of a pediatric medicine dosage cup having a cup portion and a candy coating disposed about a rim portion of the cup portion.

FIG. 2 is a side cross-sectional view of the cup of FIG. 1.

FIG. 3 is perspective view of an alternate embodiment of the pediatric medicine dosage cup of FIG. 1.

FIG. 4 is perspective view of an alternate embodiment of the pediatric medicine dosage cup of FIG. 1.

FIG. 5 is an enlarged fragmentary side cross-sectional view of the candy coating of the cup of FIG. 1.

FIG. 6 is a perspective view of a tray configured to store a plurality of the cups of FIG. 1.

FIG. 7 is a side cross-sectional view of the tray of FIG. 3.

FIG. 8 is a side cross-sectional view of the tray of FIG. 3, with a single cup of FIG. 1 mounted thereon in an inverted orientation.

FIG. 9 is a flow chart of a process of making and optionally packaging the cup of FIG. 1.

FIG. 10 is a top view of an apparatus for making the cup of FIG. 1.

FIG. 11 is a side view of the apparatus of FIG. 10.

FIG. 12 is an exploded perspective view of a conveyor of the apparatus of FIG. 10, the conveyor including a plurality of cup carriers.

FIG. 13 is a perspective view of one of the cup carriers of FIG. 12 including a single cup portion disposed on one of its cup receiving portions.

FIG. 14 is an exploded perspective view of a multi-cup magazine of the apparatus of FIG. 10 configured to place cup portions on the cup carriers of FIG. 12.

FIG. 15 is a partially exploded perspective view of an elongated member with a plurality of gripping devices of a first transfer mechanism of the apparatus of FIG. 10.

FIG. 16 is a partially exploded perspective view of a heated tray of the apparatus of FIG. 10, the tray housing and heating a flavored mixture used to form a flavored layer of the candy coating of the cup of FIG. 1.

FIG. 17 is a partially exploded perspective view of a tray of the apparatus of FIG. 10, the tray housing and agitating sugar crystals and optional acid crystals used to form a crystal layer of the candy coating of the cup of FIG. 1.

FIG. 18 is an exploded perspective view of a packaging magazine of the apparatus of FIG. 10.

FIG. 19A is a fragmentary perspective view of an embodiment of a pair of stackable trays configured to store a plurality of the cups of FIG. 3.

FIG. 19B is a perspective view of an embodiment of a pair of like stackable trays configured to store a plurality of the cups of FIG. 3.

FIG. 20 is a perspective view of a lid for use with the tray of FIG. 18.

FIG. 21 is a perspective view of a pair of stacking support members for stacking two cups, one upon the other.

FIG. 22 is perspective view of a cap illustrated with the cup of FIG. 3, the cap having a boss configured to be inserted into an end cup of a stack of cups and to help maintain the cups in a stack.

FIG. 23 is perspective view of a cap illustrated with the cup of FIG. 4, the cap having a boss configured to be inserted into an end cup of a stack of cups and to help maintain the cups in a stack.

FIG. 24 is perspective view of an alternate embodiment of the cap of FIG. 21 configured to abut a bottom portion of the cup of FIG. 3.

### DETAILED DESCRIPTION OF THE INVENTION

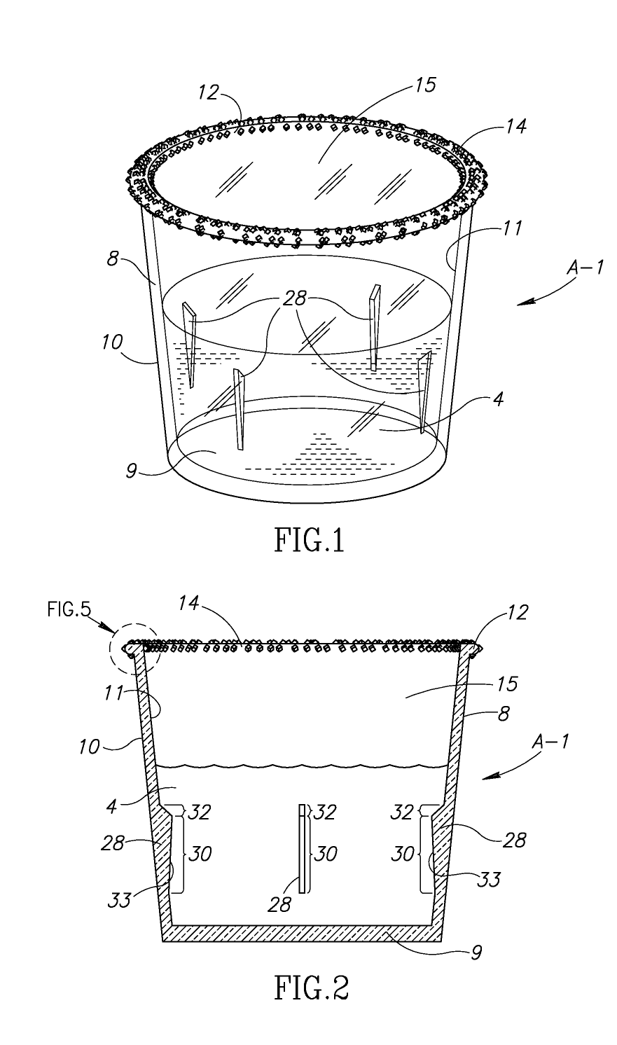

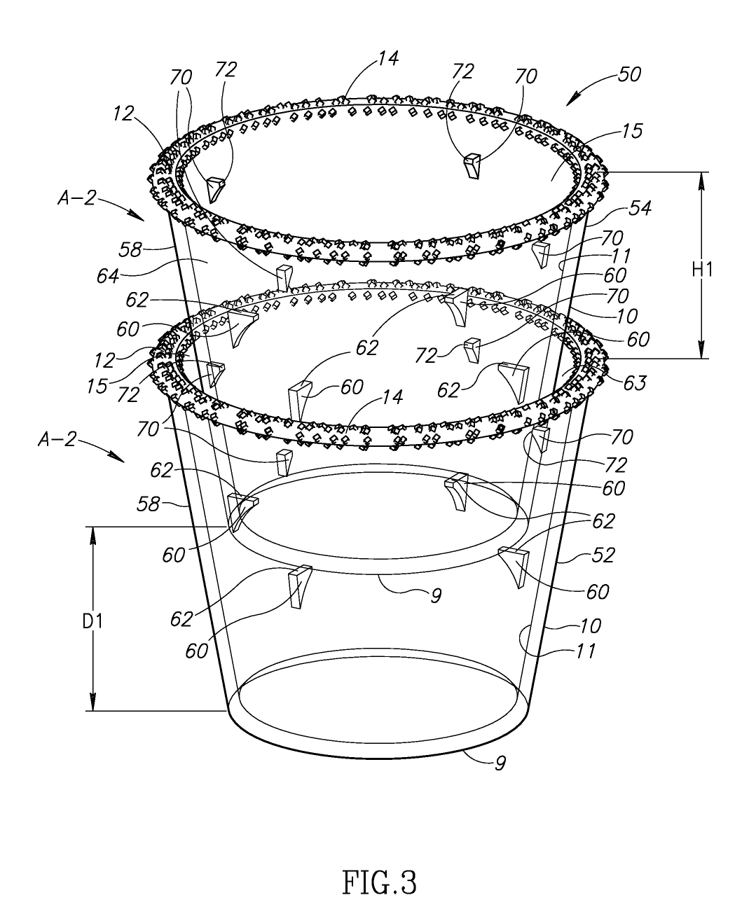

Referring to FIGS. 1 and 2, aspects of the present invention include a cup “A-1” for dispensing a liquid 4 to a user. By way of a non-limiting example, the cup “A-1” may be configured as a pediatric medicine dosage cup for dispensing a liquid pediatric medication to a child. The liquid pediatric medication may include any mediation having an undesirable flavor component, such as an analgesic, antihistamine, or diuretic having an unpleasant taste. By way of a non-limiting example, the undesirable flavor component may be a bitter flavor. Alternatively, the cup “A-1” may be used by adults. Further, the cup “A-1” may be used to dispense liquids other than pediatric medications. For example, the liquid 4 may be a beverage, such as an alcoholic beverage (e.g., a mixed drink or cocktail), juice, milk, water, soda, and the like. The cup “A-1” includes a cup portion 8 and a candy coating 14.

Cup Portion

The cup portion 8 has a bottom portion 9, and a sidewall 10 with an interior surface 11 and a rim portion 12. The sidewall 10 extends upwardly from the bottom portion 9. The interior surface 11 of the sidewall 10 and the bottom portion 9 define an interior portion 15 configured to retain the liquid 4. The cup portion 8 may be constructed using any suitable cup known in the art. For example, the cup portion 8 may be formed from an opaque plastic, transparent plastic, or a translucent plastic using any conventional cup forming process. The cup portion 8 may be constructed from any conventional medical dosage cup known in the art. By way of a non-limiting example, the cup portion 8 may be sized to hold three teaspoons of the liquid 4, which may correspond to a three teaspoon dosage of a pediatric medication. However, other cup sizes may also be utilized. The cup portion 8 may have calibrated measurement markings (not shown) satisfying FDA dosing standards.

The cup portion 8 includes a plurality of spacer ribs 28 extending radially and inwardly into the interior portion 15 from the interior surface 11 of the sidewall 10. The spacer ribs 28 are spaced apart from one another around the interior surface 11 of sidewall 10. The spacer ribs 28 have a first rib portion 30 and a second rib portion 32. The first rib portion 30 has an edge portion 33 spaced from the interior surface 11 of sidewall 10. The spacer ribs 28 are each shaped such that in the first rib portion 30, the distance the edge portion 33 of the first rib portion extends inward radially from the interior surface 11 of the sidewall 10 increases as the distance of the first rib portion 30 increases from the bottom portion 9 of the cup. In the second rib portion 32, which forms the top of the rib, the distance the second rib portion extends inward radially from the interior surface 11 of the sidewall 10 decreases rapidly as the distance of the second rib portion 32 increases from the bottom portion 9 of the cup. Accordingly, each of the spacer ribs 28 has a generally triangular shape when viewed from the side.

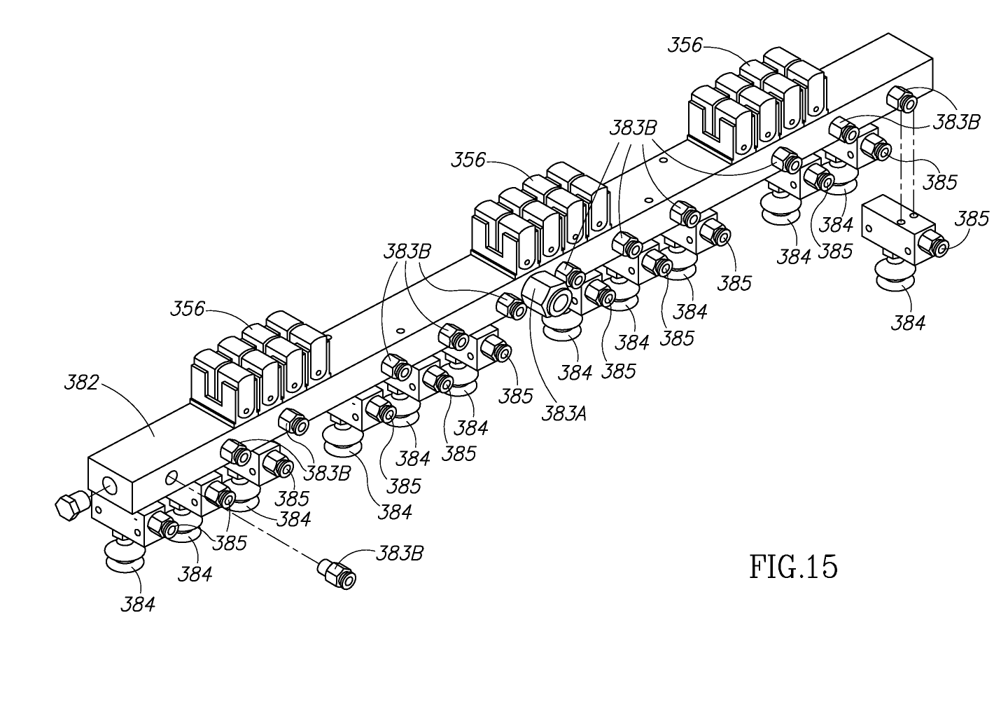

The candy coating 14 is formed on the rim portion 12 of the cup portion 8. The cup portion 8 may be configured to be nested together to form a stack 373 (depicted in FIG. 14 in an inverted orientation) of the cup portions. Further, the cup portions 8 may be configured to nest together after the candy coating 14 has been formed on their respective rim portions 12. When so nested together, to avoid damaging the candy coating 14, direct contact between the candy coating 14 on one of the cup portions 8 with another of the cup portions should be avoided. Thus, in a stack where cup portions 8 are nested inside one another, the rim portion 12 of each of the cup portions 8 should be spaced apart from the cup portion 8 of the other cups (if any) in the stack.

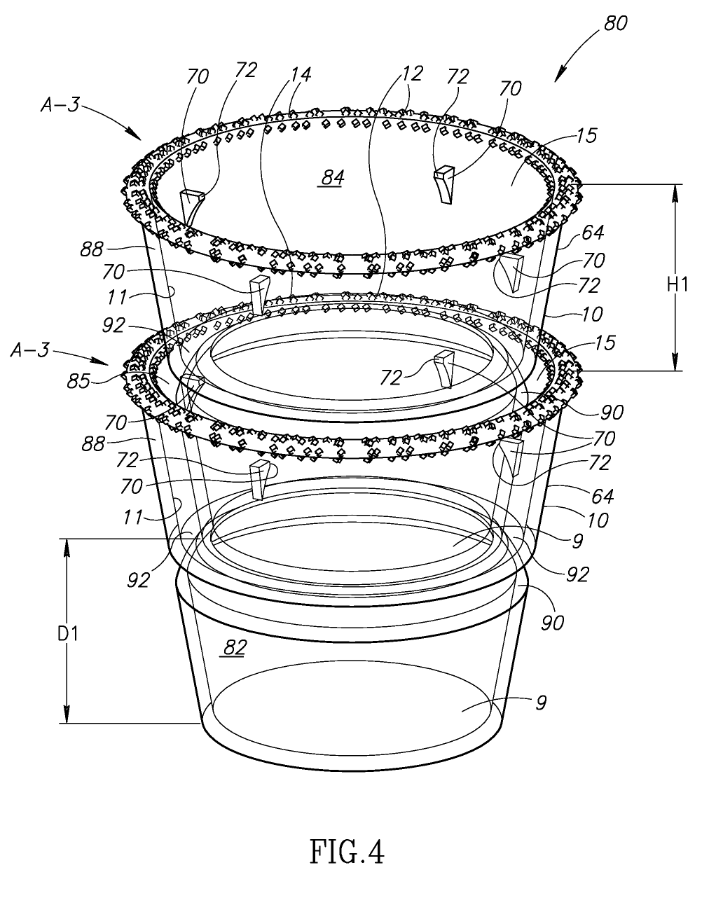

Referring to FIG. 3, an alternate embodiment of the cup “A-1” and the cup portion 8 are provided. FIG. 3 depicts a stack 50 of cups “A-2.” The stack 50 includes two cups “A-2:” a first cup 52 and a second cup 54 nested inside the first cup. Each of the cups 52 and 54 includes a cup portion 58 and the candy coating 14. Like reference numerals have been used to identify substantially similar components of the cup portion 8 and the cup portion 58.

The cup portion 58 includes a plurality of support projections 60 extending inwardly and radially from the interior surface 11 of the sidewall 10. The support projections 60 are spaced apart from one another around the interior surface 11 of sidewall 10. The support projections 60 of the first cup 52 have an upper portion 62 configured to receive and support the bottom portion 9 of the second cup 54. When nested together, the bottom portion 9 of the second cup 54 rests upon and is supported by the support projections 60 of the first cup 52. Likewise, the support projections 60 of the second cup 54 have an upper portion 62 configured to receive and support the bottom portion 9 of another cup “A-2.” Thus, the support projections 60 are configured to determine a depth “D1” at which the second cup 54 is received inside the first cup 52.

The depth “D1” may be sufficient to define a gap 63 between the rim portion 12 of the first cup 52 and the sidewall 10 of the second cup 54. Further, the depth “D1” may be sufficient to space a gripping portion 64 of the second cup 54 from the interior portion 15 of the first cup 52, placing the gripping portion outside the first cup 52 thereby exposing the gripping portion to the user. The user may remove the second cup 54 from the first cup 52 by grasping the gripping portion 64 of the second cup 54 and lifting it from inside the first cup 52. The gripping portion 64 may be large enough to allow the user to grasp the gripping portion 64 without disturbing the candy coating 14 on the rim portions 12 of the first and second cups 52 and 54. By way of a non-limiting example, the gripping portion 64 may have a height “H1” of about one inch to about 1.25 inches.

The cup portion 58 includes a plurality of spacer projections 70 extending inwardly and radially from the interior surface 11 of the sidewall 10. The spacer projections 70 are spaced apart from one another around the interior surface 11 of sidewall 10. The spacer projections 70 are spaced from the support projections 60 toward the rim portion 12. Each of the spacer projections 70 has an abutting portion 72. When the second cup 54 is nested inside the first cup 52, the abutting portion 72 of the spacer projections 70 of the first cup 52 abut the sidewall 10 of the cup portion 58 of the second cup 54.

The spacer projections 70 help maintain the gap 63 defined between the rim portion 12 of the first cup 52 and the sidewall 10 of the second cup 54. Thus, the spacer projections 70 help prevent the candy coating 14 on the rim portion 12 of the first cup 52 from contacting the sidewall 10 of the second cup 54. Because contact between the candy coating 14 of the first cup 52 and the sidewall 10 of the second cup 54 can damage the candy coating, the spacer projections 70 help prevent damage to the candy coating 14. The spacer projections 70 of the first cup 52 may be configured to substantially center the second cup 54 inside the first cup 52 and prevent radially directed shifting of the second cup 54 inside the first cup 52 that may disturb or damage the candy coating of the first cup 52. This added stacking stability may also help prevent the stack 50 from toppling over.

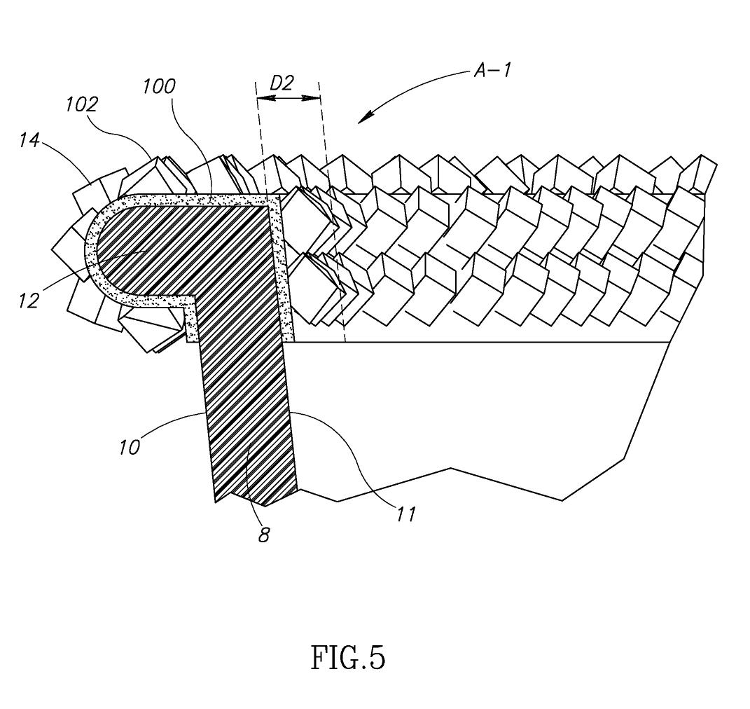

Referring to FIG. 4, an alternate embodiment of the cup “A-2” and the cup portion 58 is provided. FIG. 4 depicts a stack 80 of cups “A-3.” The stack 80 includes two cups “A-3:” a first cup 82 and a second cup 84 nested inside the first cup. Each of the cups 82 and 84 includes a cup portion 88 and the candy coating 14. Like reference numerals have been used to identify substantially similar components of the cup portion 58 (see FIG. 3) and the cup portion 88.

Unlike the cup portion 58, which includes a plurality of circumferentially spaced apart support projections 60, each of the cup portions 88 includes a single support projection that extends inwardly and circumferentially around the cup portion 88. Specifically, each of the cup portions 88 includes a support projection or narrowed portion 90 formed in the sidewall 10 between the bottom portion 9 and the spacer projections 70. In the narrowed portion 90, the sidewall 10 extends radially and inwardly into the interior portion 15 of the cup portion 88. In the embodiment depicted, the narrowed portion 90 gives the cup portion 88 a modified hourglass shape. However, this is not a requirement. The interior surface 11 of the sidewall 10 includes a support portion 92 adjacent the narrowed portion 90 formed in the sidewall 10. In the embodiment illustrated, the narrowed portion 90 is formed between the support portion 92 and the bottom portion 9.

The support portion 92 of the cup portion 88 is configured to receive and support the bottom portion 9 of the second cup 84. When nested together, the bottom portion 9 of the second cup 84 rests upon and is supported by the support portion 92 of the first cup 82. Likewise, the support portion 92 of the second cup 84 is configured to receive and support the bottom portion 9 of another cup “A-3.” Thus, the support portion 92 is configured to determine the depth “D1” at which the second cup 84 is received inside the first cup 82. The depth “D1” defines a gap 85 between the rim portion 12 of the first cup 82 and the sidewall 10 of the second cup 84. The gap 85 may be defined between the rim portion 12 of the first cup 82 and the narrowed portion 90 of the second cup 84. Alternatively, the gap 85 may be defined between the rim portion 12 of the first cup 82 and a portion (not shown) of the sidewall 10 of the second cup 84 located between its narrowed portion 90 and the rim portion 12.

Candy Coating

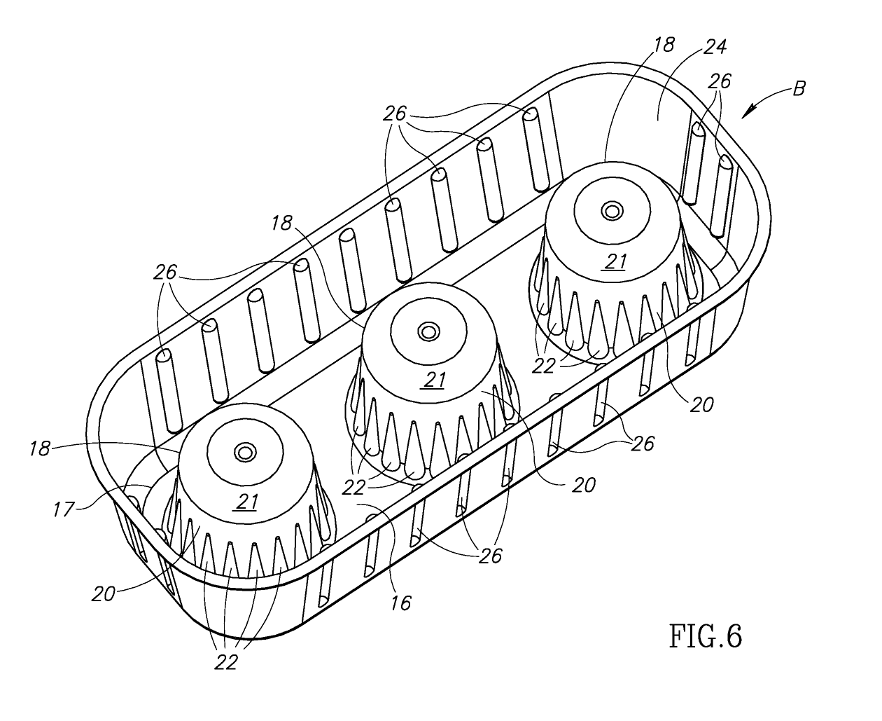

Turning to FIG. 5, as mentioned above, the candy coating 14 is formed on the rim portion 12 of the cup portion 8. When the cup “A-1” is used to dispense pediatric medications, the candy coating 14 masks the taste of the medicine making it more palatable for the user. The candy coating 14 may be characterized as “chasing away” the taste of the medicine by tricking the user's palette with a sour flavor that is different from the flavor of the medicine. The candy coating 14 is made of sugar, natural colors, an acid component, and natural flavors. The acid component imparts the sour flavor in the candy coating 14. Optionally, the candy coating 14 may include agar but this is not a requirement. Further, artificial colors instead of or in addition to the natural colors may be included in the candy coating 14. Also, artificial flavors may be included in the candy coating 14 instead of or in addition to the natural flavors.

The candy coating 14 extends a distance “D2” into the interior portion 15 of the cup portion 8 from the interior surface 11 of the sidewall 10. The candy coating 14 has two layers: a flavored layer 100 and a crystal layer 102. The flavored layer 100 is applied as a liquid and allowed to harden onto the rim portion 12 of the cup “A-1.” The flavored layer 100 includes sugar, an acid component, and flavoring. Optionally, the flavored layer 100 may include agar. However, agar has been found to be unnecessary in certain embodiments.

The crystal layer 102 includes sugar crystals optionally colored with one or more colorings. Optionally, the crystal layer 102 includes acid crystals (e.g., citric acid crystals). By way of a non-limiting example, the crystal layer 102 may include about 5% to about 10% acid crystals and about 90% to about 95% sugar crystals. By way of another non-limiting example, the crystal layer 102 may include about 6% to about 7% acid crystals and about 93% to about 94% sugar crystals. The sugar and/or acid crystals may include one or more flavorings.

The sugar crystals and optional acid crystals are applied to the flavored layer 100 before the flavored layer is completely solid. The sugar crystals and optional acid crystals stick to the liquid or semi-liquid flavored layer 100 thereby forming the crystal layer 102, which is loosely adhered to the rim portion 12 when the flavored layer 102 hardens or crystallizes.

When a user drinks from the cup “A-1,” at least a portion the loosely adhered crystal layer 102 readily flakes off the rim portion 12 onto the user's lips and into the user's mouth. Further, when the liquid 4 (see FIGS. 1 and 2) exits the cup “A-1,” the liquid passes over the crystal layer 102 dissolving at least a portion of the crystal layer 102, and carries the portion of the crystal layer 102 into the user's mouth. Once the portion of the crystal layer 102 is removed, a portion of the flavored layer 100 underneath is exposed. The user's saliva and the liquid 4 exiting the cup “A-1” dissolve the exposed flavored layer 100. Thus, the sugar crystals and optional acid crystals of the crystal layer 102 and the sugar, flavoring, and acid component of the flavored layer 100 mingle with the liquid 4 (see FIGS. 1 and 2) inside the user's mouth, changing the flavor of the liquid. Without being limited by theory, it is believed the acid component of the flavored layer 100 masks (or chases away) certain undesirable flavors (e.g., bitterness) present in the liquid 4 thereby making the liquid more palatable.

Masking is a complete or partial reduction in the intensity of a first sensation (caused by the liquid) as a function of another stimuli or sensation present at the same time (i.e., the dissolved candy coating). For example, the primary taste attributes of bitterness or sourness may be masked (i.e., their intensity diminished) by the addition of another primary taste attribute such as sweet or a strong flavor such as blackcurrant. By way of another example, sugar may be used to mask sourness in coffee and rhubarb. In the present application, sourness is used to mask (or chase away) undesirable flavors in medicine, which may include a sweetener, flavoring (e.g., grape flavor), and the like. For example, the sourness of the acid component may chase away an excessively sweet flavor present in the medicine.

Taste sensations have been divided into four primary tastes: sweet, sour, bitter, and salty. Each of the primary tastes stimulates taste buds located in specific regions of the tongue. The region for sweet is located at the tip and front of the tongue. The regions for sour and salty are located on the sides of the tongue. The region for bitter is located at the back of the tongue. However, studies have shown that individual taste buds can be stimulated by more than one primary taste with one or two predominating. Without being limited by theory, it is believed that the addition of a sufficient amount of the acid compound to the flavored layer 100 confuses or tricks the taste buds thereby masking certain undesirable flavors (such as bitterness) in the liquid 4. The amount of the acid compound relative to the amount of sugar and flavoring used to construct the flavored layer 100 is described below.

Tray

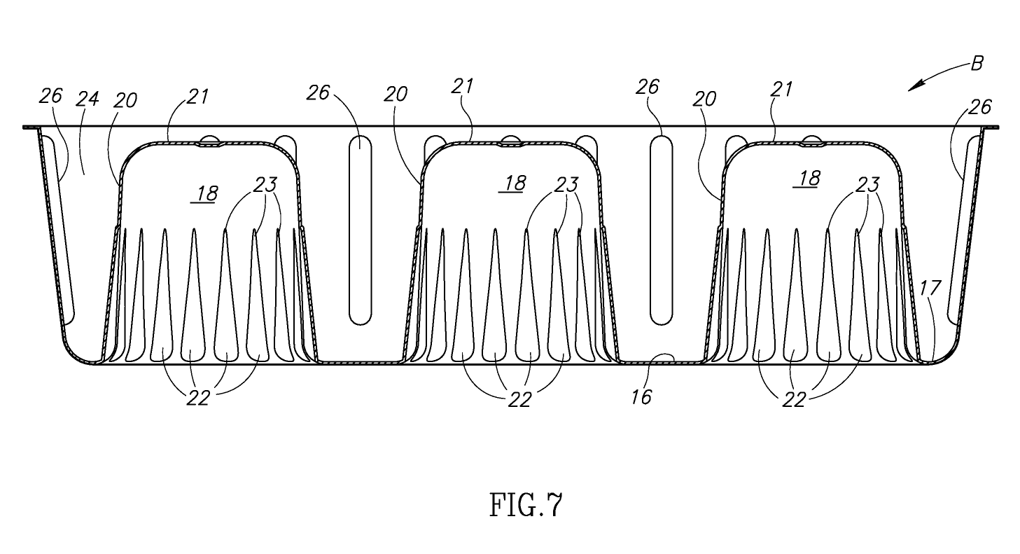

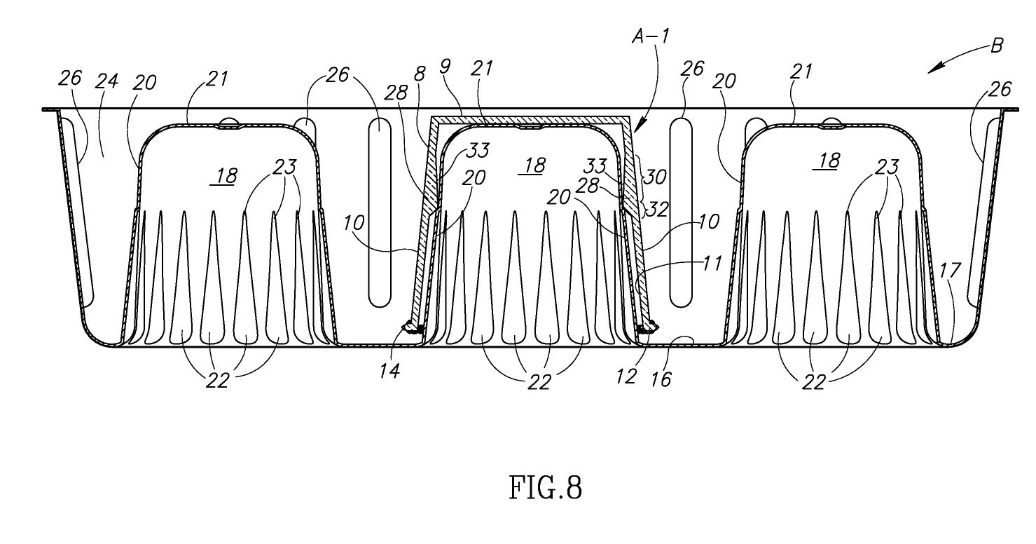

FIGS. 6, 7, and 8 depict a tray “B” configured to store a plurality of the cups “A-1” (illustrated in FIGS. 1 and 2). The implementation of the tray “B” depicted in the figures is intended to hold three cups “A-1.” However, those of ordinary skill in the art appreciate that trays with similar structure for holding different numbers of cups are within the scope of the present teachings.

Each tray “B” has a bottom surface 16 with a peripheral portion 17 and a plurality (in this case, three) of spaced apart bosses 18 spaced inwardly from the peripheral portion 17 of the bottom surface 16 and projecting upwardly therefrom. Each of the bosses 18 includes an upwardly extending sidewall 20 and a closed top portion 21. Each of the bosses 18 has the general shape of an inverted cups “A-1” but is slightly smaller than a cup “A-1” such that an inverted cup “A-1” can be received over the boss. The sidewall 20 of each of the bosses 18 includes a plurality of circumferentially spaced reinforcing ribs 22 that increase the structural rigidity of the boss. Each of the reinforcing ribs 22 extends along the sidewall 20 from the bottom surface 16 of the tray “B” upwardly toward the closed top portion 21. Optionally, each of the reinforcing ribs 22 may be tapered, narrowing from the bottom surface 16 toward the closed top portion 21 and terminating in a rounded point 23. In the embodiment illustrated, each of the reinforcing ribs 22 extends radially outwardly from one of the bosses 18. However, this is not a requirement, and embodiments in which the reinforcing ribs 22 extend radially inwardly are also within the scope of the present teachings.

The tray “B” also includes an upright peripheral wall 24 extending along the peripheral portion 17 of the bottom surface 16. The upright peripheral wall 24 surrounds the bosses 18 and is spaced apart therefrom. The peripheral wall 24 also includes spaced apart reinforcing ribs 26, which may increase the structural rigidity of the wall. The reinforcing ribs 26 may have substantially uniform widths.

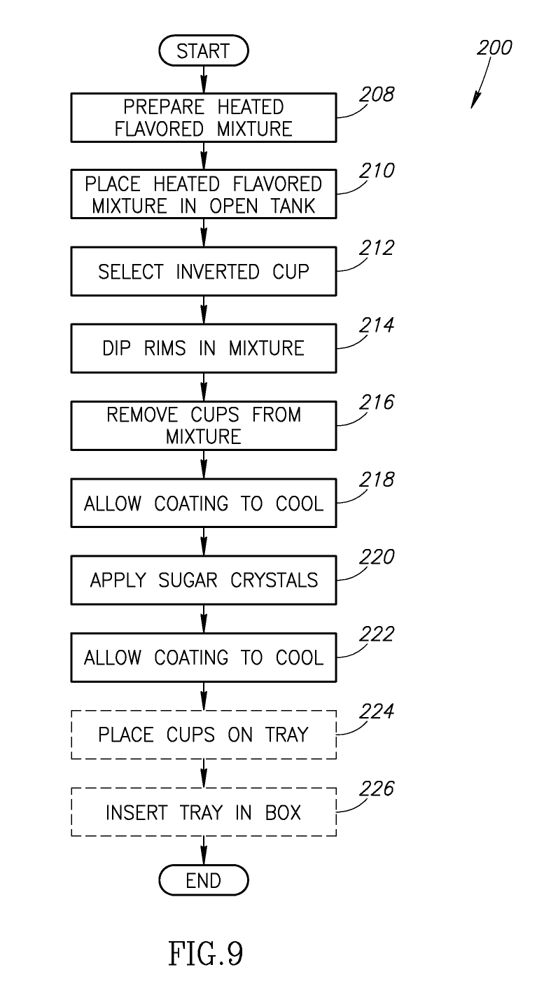

As described above, tray “B” is designed to hold a number of cups “A-1.” An inverted cup “A-1” may be placed over a different one of the bosses 18 of the tray “B.” FIG. 8 shows one inverted cup “A-1” mounted on one of the bosses 18 of the tray “B.” When a cup “A-1” is so mounted on one of the bosses 18, the edge portion 33 of first rib portion 30 of each of the spacer ribs 28 abuts the sidewall 20 of the boss 18, spacing the interior surface 11 of the cup portion 8 from the sidewall 20 of the boss 18. The spacer ribs 28 insure that the cups “A-1” can be removed easy by the user from the bosses 18 without dislodging or damaging the candy coating 14 disposed on the rim portion 12 of the cup portion 8. The spacer ribs 28 also prevent contact between the candy coating 14 and the sidewall 20 of the boss 18 that could potentially damage the candy coating 14.

When a cup “A-1” is mounted on one of the bosses 18, the closed top portion 21 may abut and support the bottom portion 9 of the cup portion 8. Thus, the height of the sidewall 20 may determine the spacing between the candy coating 14 on the rim portion 12 of the cup portion 8 and the bottom surface 16 of the tray “B.” In particular embodiments, the height of the sidewall 20 may be sufficient to prevent contact between the candy coating 14 and the bottom surface 16 of the tray “B” that could potentially damage the candy coating 14.

Fabrication Process

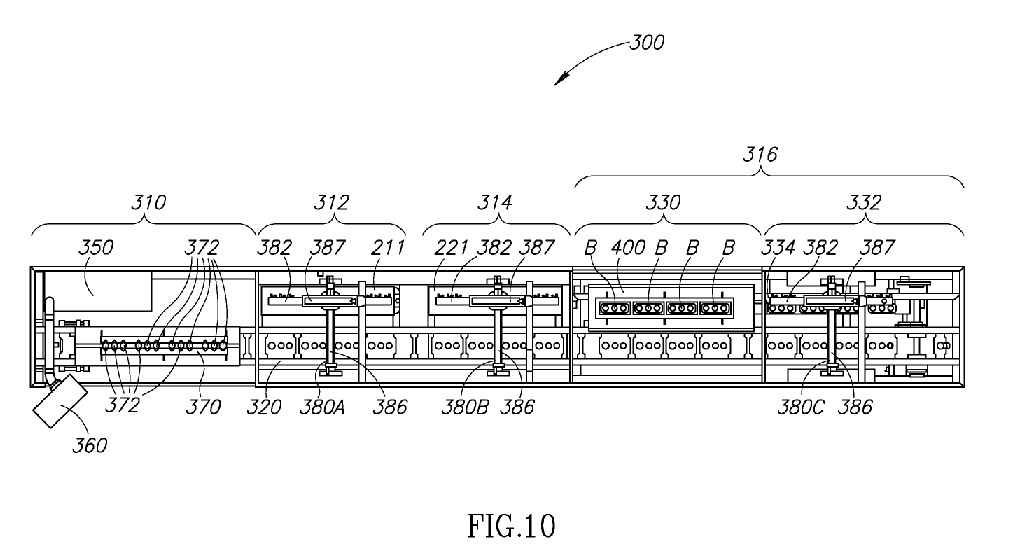

The cup “A-1” may be fabricated using a continuous manufacturing process 200, as set forth in the flow chart of FIG. 9. In first block 208, a heated flavored mixture used to form the flavored layer 100 (see FIG. 5) is prepared. As mentioned above, the flavored layer 100 includes sugar, water, the acid component, and flavoring. Because some food colorings may be discolored by the acid component and/or the heating process, it may be desirable to omit coloring from the heated flavored mixture. However, this is not a requirement and embodiments in which coloring is added to the heated flavored mixture are within the scope of the present teachings. In block 208, the sugar, water, acid component, and flavorings may be mixed together and heated to a temperature between approximately 140° F. to approximately 160° F. In particular embodiments, the heated flavored mixture may be heated to approximately 150° F. and maintained at that temperature. It has been found that heating the flavored mixture to about 160° F. or more produces a flavored layer 100 that fails to harden and remains sticky.

As is appreciated by those of ordinary skill in the art, when a sugar solution is heated, a certain percentage of sucrose breaks down to form “invert sugar.” An inverted sugar syrup is a sucrose-based syrup produced with an glycoside hydrolase enzyme invertase or an acid that splits each sucrose disaccharide molecule into its component glucose and fructose monomer molecules. Invert sugar's glucose is substantially more hygroscopic than sucrose, imparting a longer lasting moistness to products than sucrose alone. This invert sugar inhibits sucrose crystallization and increases the overall concentration of sugars in the mixture. The natural process of inversion is difficult to accurately assess making it difficult to determine the amount of invert sugar that will be produced.

An acid enables but is not consumed by the reaction. The rate of the reaction depends upon the temperature and concentration of the reactants. More concentrated solutions require more time to achieve a given conversion at a given temperature. Citric acid may be used to control the amount of inversion by accelerating the breakdown of sucrose into invert sugar, and thereby increasing the overall percentage of invert sugar in the solution.

As mentioned above, the heated flavored mixture prepared in block 208 is used in subsequent blocks to form the flavored layer 100 of the cup “A-1.” The formation of the flavored layer 100 may be complicated by the inversion process. The citric acid added to mask flavors in the liquid 4 in the cup “A-1” accelerates the formation of invert sugar. Likewise, heating the flavored mixture may accelerate the formation of invert sugar. Too much invert sugar may make the flavored layer 100 prone to absorbing moisture from the air causing the flavored layer 100 to become sticky.

Further, too much invert sugar in the flavored mixture may prevent it from crystallizing. For example, if invert sugar comprises about 10-15 percent of the flavored mixture, a non-crystalline flavored layer 100 may result. Because it is desirable for the flavored layer 100 to harden or crystallize, the amount of invert sugar should be low enough to permit the flavored layer 100 to crystallize. Thus, the temperature to which the flavored mixture is heated and the amount of the acid component (e.g., citric acid) must be carefully balanced in accordance with the present teachings to produce the crystallized flavored layer 100.

Table A below provides non-limiting examples of ingredients and their respective proportions used to construct particular embodiments of the heated flavored mixture.

TABLE A

| Water/Sugar Slurry | Sour Cherry | Watermelon | Sour Apple |
|---|---|---|---|
| Sugar | 67.87% | 67.26% | 66.96% |
| Water | 15.84% | 15.70% | 15.63% |
| Flavor | 1.81% | 2.69% | 3.13% |
| Citric Acid Solution | 14.48% | 14.35% | 14.29% |
| (50 H₂O/50 acid) | | | |
| Total | 100% | 100% | 100% |

As may be viewed in Table A, the heated flavored mixture includes about 7% to about 8% citric acid by weight. Depending upon the implementation details, the acid component may be about 10% to about 20% of the heated flavored mixture by weight. In alternate implementations, the acid component may be about 4% to about 8% of the heated flavored mixture by weight. In such embodiments, the heated flavored mixture may include about 72% (solid) sugar and about 2.5% flavoring by weight.

After the heated flavored mixture has hardened to form the flavored layer 100 (see FIG. 5), the citric acid present in the hardened flavored layer 100 is sufficient to mask undesirable flavors in the liquid 4 (see FIGS. 1 and 2). By way of a non-limiting example, the flavorings listed in Table A may be purchased from Green Mountain Flavors, Inc. of Oswego, Ill.

Organic acids, such as citric, malic, tartaric, lactic, etc., give a sharp or sour flavor to fruits, may be used. These “fruit acids” are a group of organic acids that share a common chemical structure consisting of a hydroxyl group positioned at the alpha-carbon position. Consequently, these compounds are often referred to as “alpha hydroxy acids.” Common fruit acids include citric acid, lactic acid, and malic acids. While the acid component has been described as being citric acid, other organic acids, alpha hydroxy acids, and the like may be used. Non-limiting examples of suitable acids include citric acid, malic acid, tartaric acid, fumaric acid, propionic acid, acetic acid, lactic acid, and the like. The optional acid crystals may formed from any suitable acid known in the art including any of the aforementioned acids.

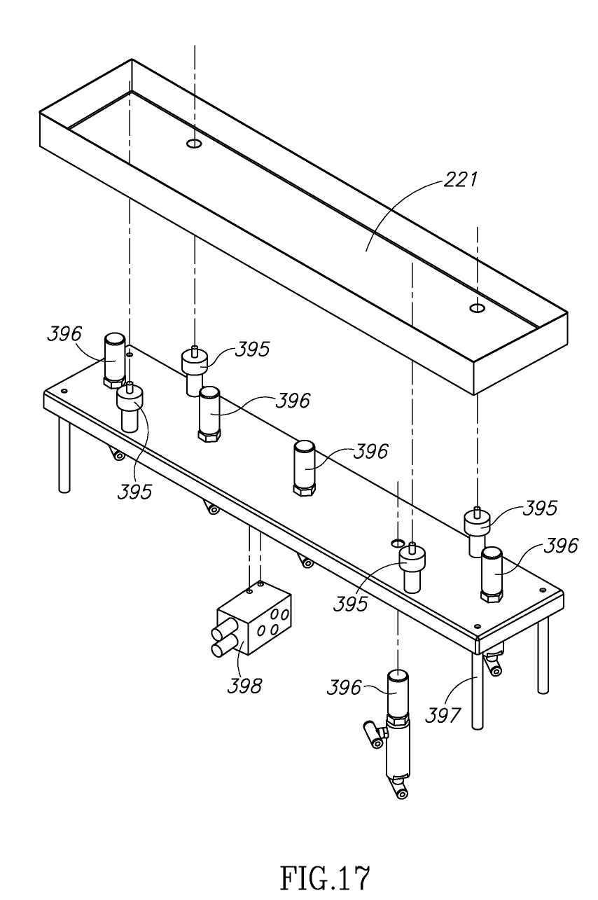

Then, in block 210, at least a portion of the heated flavored mixture prepared in block 208 is placed in an open vessel, such as a heated tray 211 (see FIG. 16). The heated flavored mixture may be initially mixed and heated in a separate container and added to the tray 211 as needed. The heated flavored mixture in the separate container maybe agitated continuously. As it is consumed, additional quantities of the heated flavored mixture may be ladled into the tray 211 to replace the heated flavored mixture removed therefrom. By way of a non-limiting example, heated flavored mixture may be ladled into the tray 211 using a stainless steel scoop.

In next block 212, one or more inverted uncoated cup portions 8 is selected. In block 214, the inverted cup portion 8 is lowered into the heated flavored mixture such that the rim portion 12 of the cup portion 8 is submerged in the heated flavored mixture.

In block 216, the cup portion 8 is removed from the tray 211 and in block 218, allowed to partially cool, for about 2 seconds to about 10 seconds, such that the heated flavored mixture on the rim portion 12 of the cup portion 8 begins to crystallize or harden and become tacky.

In block 220, the sugar crystals and optional acid crystals are applied to the still warm, now tacky (or partially crystalized) heated flavored mixture on the rim portion 12 of the cup portion 8 to form the crystal layer 102 (see FIG. 5) thereby completing the candy coating 14. The sugar crystals and optional acid crystals may be applied to the rim portion 12 by blowing the crystals onto the rim portion 12. Alternatively, the sugar crystals and optional acid crystals may be applied to the rim portion 12 by dipping the rim portion 12 of the cup portion 8 into an open tray 221 housing the crystals. The sugar crystals and optional acid crystals loosely adhere to the heated flavored mixture on the rim portion 12.

In block 222, the heated flavored mixture on the rim portion 12 of the cup portion 8 may be allowed to cool until it is completely cool and solid. For example, in block 222, the heated flavored mixture on the rim portion 12 may be allowed to cool for about 30 seconds to about 40 seconds. The solid or crystalized flavored mixture loosely retains the sugar crystals and optional acid crystals such that when a user places his/her lips against the rim portion 12 of the cup portion 8, the crystals readily disengage therefrom. After the heated flavored mixture on the rim portion 12 has cooled, the process 200 has constructed the cup “A-1.”

In optional blocks 224 and 226, one or more cups “A-1” may be packaged for sale, distribution, and/or shipment. In optional block 224, the cups “A-1” are loaded into one or more of the trays “B” (see FIGS. 6-8) In the embodiment of the tray “B” illustrated in FIGS. 6-8, three cups “A-1” may be loaded into or mounted on one tray “B.” Then, in optional block 226, one or more of the trays “B” with the cups “A-1” mounted thereon may be packaged together in a box (not shown). Prior to placing the trays “B” in the box (not shown), the individual trays may be wrapped in plastic (not shown) such that they remain sanitary.

Alternatively, in block 222, the heated flavored mixture on the rim portion 12 of the cup portion 8 may be cooled for less time than is required to cool the mixture completely. In such embodiments, one or more cup portions 8 with partially cooled heated flavored mixture on their rim portions 12 are loaded into one or more of the trays “B” (see FIGS. 6-8). In the embodiment of the tray “B” illustrated in FIGS. 6-8, three cup portions 8 with partially cooled heated flavored mixture on their rim portions 12 may be loaded into or mounted on one tray “B.” Then, in optional block 226, one or more of the trays “B” with the cup portions 8 mounted thereon may be packaged together in a box (not shown). Prior to placing the trays “B” in the box (not shown), the individual trays may be wrapped in plastic (not shown) such that they remain sanitary.

While the flavored mixture prepared in block 208 and used to form the flavored layer 100 of the cup “A-1” has been described as being heated, those of ordinary skill in the art appreciate that based on the implementation details a non-heated mixture of the sugar, water, acid component, and flavoring may be used instead and such embodiments are within the scope of the present disclosure.

Apparatus

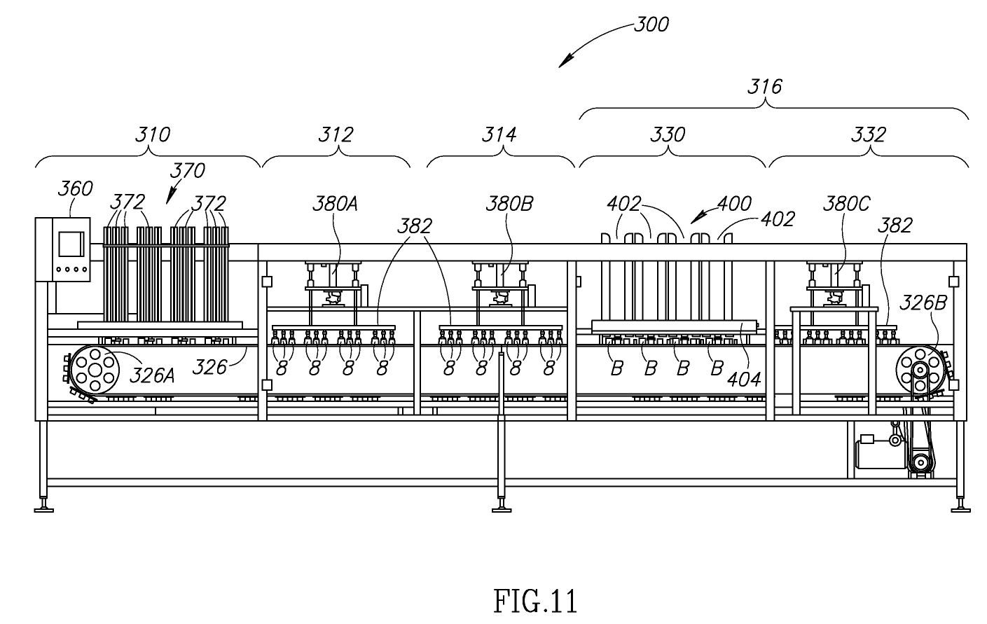

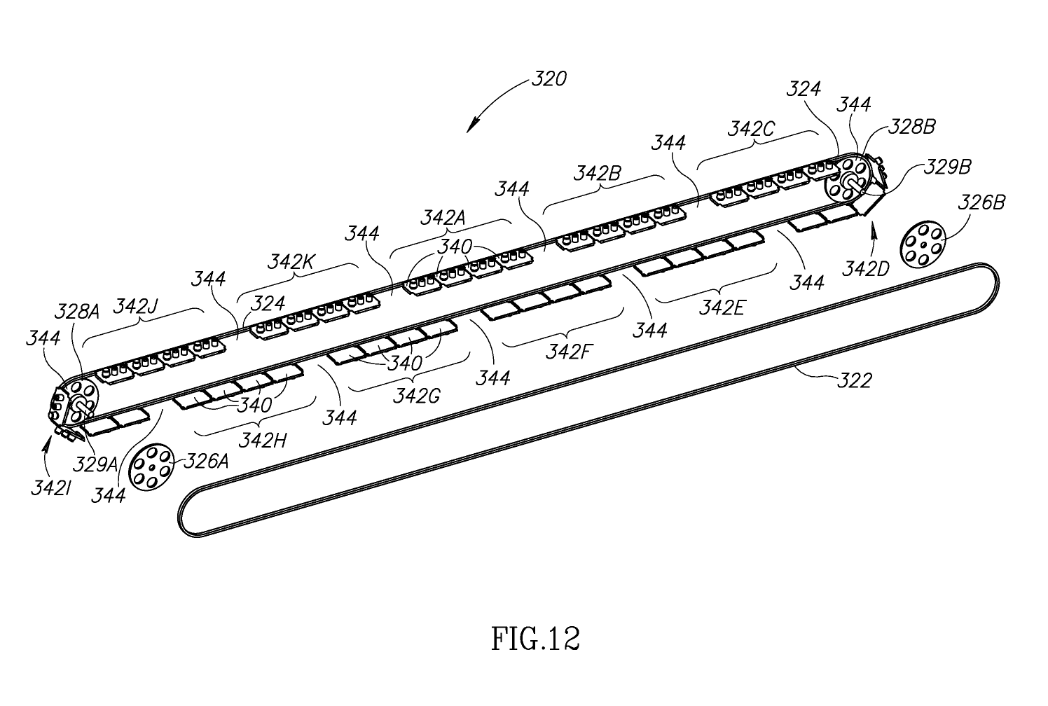

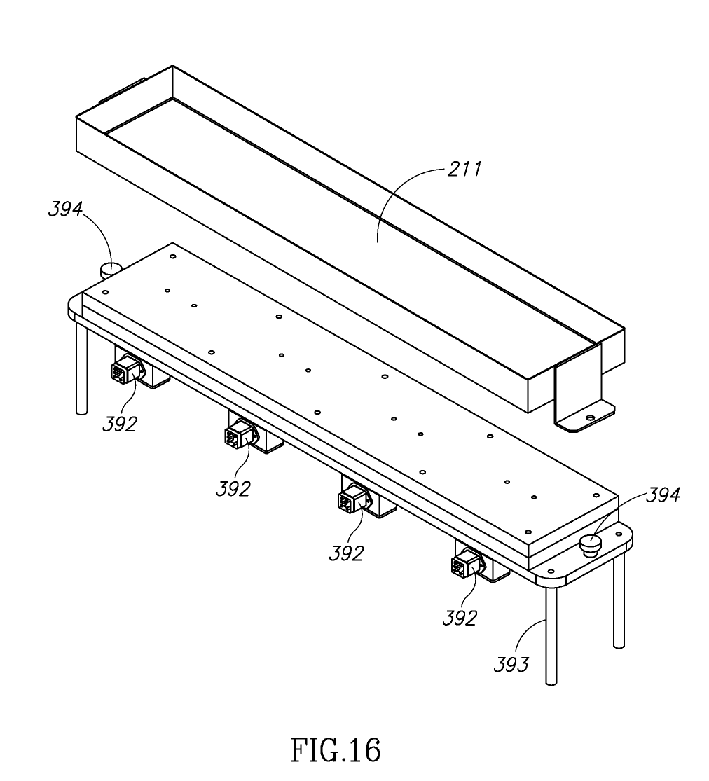

An apparatus 300 illustrated in FIGS. 10-17 may be used to perform the process 200 illustrated in FIG. 9. Turning to FIGS. 10 and 11, the apparatus 300 may be characterized as having four stations arranged in the following sequence: a de-nesting station 310; a liquid coating station 312; a crystal coating station 314, and a packaging station 316. The apparatus 300 has a conveyor 320 that transports the cup portions 8 (see FIGS. 1 and 2) from the de-nesting station 310 to the liquid coating station 312, then to the crystal coating station 314, and finally to the packaging station 316. The packaging station 316 of the apparatus 300 may include a first stage 330, a second stage 332, and a packaging conveyor 334 that transports packaging materials from the first stage 330 to the second stage 332.

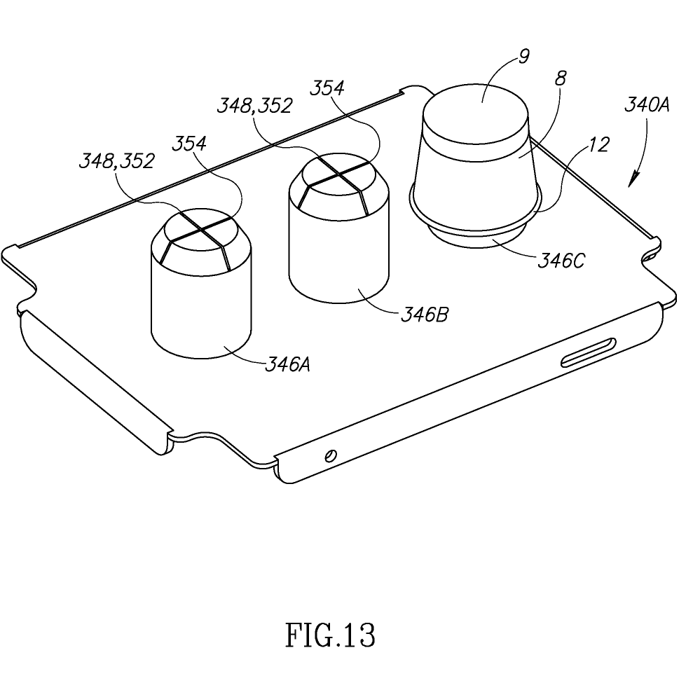

Referring to FIG. 12, the conveyor 320 has two spaced apart longitudinally extending chains 322 and 324 each forming a continuous loop. The chains 322 and 324 are each looped around a first sprocket 326A and 328A, respectively, adjacent the de-nesting station 310 and a second sprocket 326B and 328B, respectively, adjacent the second stage 332 of the packaging station 316. The first sprockets 326A and 328A may be coupled together to rotate about a common axle 329A and the second sprockets 326B and 328B may be coupled together to rotate about a common axle 329B.

A plurality of cup carriers 340 are coupled to and extend between the chains 322 and 324. The cup carriers 340 may be arranged on the conveyor 320 in groupings 342A-K. In the embodiment illustrated, each of the groupings 342A-K include four cup carriers 340 arranged in series along the conveyor 320 with a gap 344 defined between each adjacent pair of groupings.

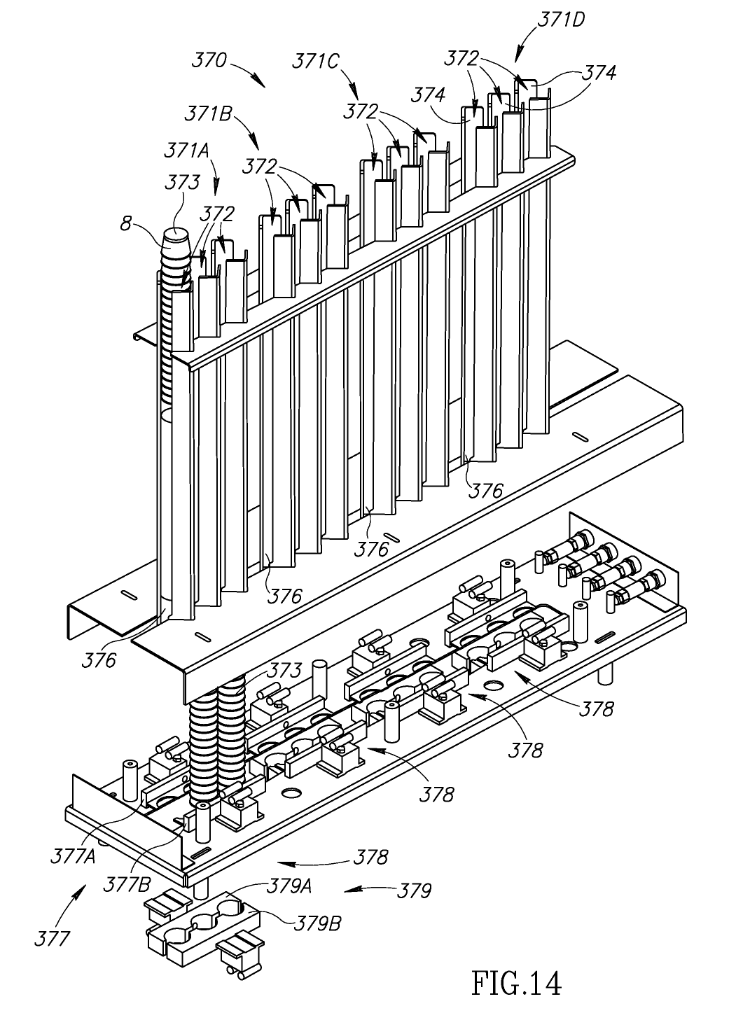

FIG. 13 depicts an embodiment of one of the cup carriers 340A. The cup carrier 340A has a predetermined number of cup receiving portions 346A, 346B, and 346C each configured to hold a single inverted cup portion 8. In the embodiment illustrated, each of the cup carriers 340 has three cup receiving portions 346A, 346B, and 346C; however, this is not a requirement. For ease of illustration, in FIG. 13, only the cup receiving portions 346C is depicted as having received an inverted cup portion 8.

Each of the cup receiving portions 346A, 346B, and 346C may have an open-ended hollow interior portion 348 in communication with the outside environment on the underside of the cup carrier 340. One or more through holes 354 are arranged on the cup receiving portions 346A, 346B, and 346C to be under an inverted cup portion 8 when the inverted cup portions 8 are received by the cup receiving portions 346A, 346B, and 346C. If one of the cup receiving portions 346A, 346B, and 346C (e.g., the cup receiving portion 346C) has received an inverted cup portion 8, the through holes 354 interconnect the hollow interior portion 348 of the cup receiving portion 346C with the interior portion 15 (see FIGS. 1 and 2) of the cup portion 8. The interior surface 11 of the sidewall 10 defining the interior portion 15 limits the flow of air from inside the hollow interior portion 348 of the cup receiving portion 346C through the through holes 354. On the other hand, if one of the cup receiving portions 346A, 346B, and 346C (e.g., the cup receiving portion 346A) has not received an inverted cup portion 8, air may flow from inside the hollow interior portion 348 of the cup receiving portion 346A through the through holes 354. Thus, the through holes 354 are in communication with either the environment outside the hollow interior portion 348 or the interior portion 15 of the inverted cup portion 8 depending upon whether the cup receiving portions 346A, 346B, and 346C have received an inverted cup portion 8.

The apparatus 300 may include a controller 360 (see FIGS. 10 and 11) configured to regulate and control the operation of various components of the apparatus.

The cup receiving portions 346A, 346B, and 346C are each configured to receive a cup portion 8 without contacting its rim portion 12. By way of a non-limiting example, the edge portions 33 of the spacer ribs 28 (see FIG. 2) of the cup portion 8 may abut one of the cup receiving portion 346A, 346B, and 346C spacing the interior surface 11 of the cup portion 8 therefrom. The distance the spacer ribs 28 extend into the interior portion 15 may be determined at least in part by the distance “D2” (see FIG. 5) the candy coating 14 extends into the interior portion 15 of the cup portion 8 from the interior surface 11. In particular embodiments, the distance the spacer ribs 28 extend into the interior portion 15 of the cup portion 8 is greater than the distance “D2” (see FIG. 5), the candy coating 14 extends into the interior portion 15 of the cup portion 8.

Turning to FIGS. 10, 11, 12, and 14, at the de-nesting station 310, the uncoated cup portions 8 are loaded upside-down into a multi-cup magazine 370 positioned above the conveyor 320. The magazine 370 includes sets 371A-D of open ended channels 372 each having a first open end portion 374 opposite a second open end portion 376. Each channel is configured to receive an inverted stack 373 of cup portions 8 into its first open end portion 374.

A stop assembly 378 is adjacent the second open end portion 376 of each of the sets 371A-D of channels 372. Each stop assembly 378 includes an upper stop 377 above a lower stop 379. The upper stop 377 has a first stop portion 377A juxtaposed with a second stop portion 377B. The first stop portion 377A and the second stop portion 377B are moveable between an open position (depicted in FIG. 14) and a closed position relative to one another and a corresponding one of the channels 372. In the open position, the first and second stop portions 377A and 377B are positioned far enough apart from one another to allow a cup portion 8 to pass therebetween. In the closed position, the first and second stop portions 377A and 377B are positioned close enough together to stop a cup portion 8 from passing therebetween. To transition between the open and closed positions, the first and second stop portions 377A and 377B are moved toward one another. To transition between the closed and open positions, the first and second stop portions 377A and 377B are moved away from one another.

The lower stop 379 also has a first stop portion 379A juxtaposed with a second stop portion 379B. The first stop portion 379A and the second stop portion 379B are moveable between an open position and a closed position (depicted in FIG. 14) relative to one another and a corresponding one of the channels 372. In the open position, the first and second stop portions 379A and 379B are positioned far enough apart from one another to allow a cup portion 8 to pass therebetween. In the closed position, the first and second stop portions 379A and 379B are positioned close enough together to stop a cup portion 8 from passing therebetween. To transition between the open and closed positions, the first and second stop portions 379A and 379B are moved toward one another. To transition between the closed and open positions, the first and second stop portions 379A and 379B are moved away from one another.

Each of the stop assemblies 378 releases a single inverted cup portion 8 from each of the second open end portions 376 of the channels 372 in response to an instruction received from the controller 360. To release a single inverted cup portion 8, the first and second stop portions 377A and 377B of the upper stop 377 are placed in the closed position and a first inverted cup portion 8 of the inverted stack 373 is allowed to rest on the closed first and second stop portions 377A and 377B. Before the first and second stop portions 377A and 377B are transitioned into the open position, the first and second stop portions 379A and 379B of the lower stop 379 are placed in the closed position. Then, the first and second stop portions 377A and 377B are transitioned into the open position and the first inverted cup portion 8 of the inverted stack 373 passes between the first and second stop portions 377A and 377B. The first inverted cup portion 8 is stopped by and rests upon the first and second stop portions 379A and 379B of the lower stop 379. Before a second inverted cup portion 8 can pass between the first and second stop portions 377A and 377B, they are transitioned to the closed position. As the first and second stop portions 377A and 377B are transitioned to the closed position, the first and second stop portions 379A and 379B of the lower stop 379 are placed in the open position allowing the first inverted cup portion 8 of the inverted stack 373 to pass therebetween to be received by one of the cup receiving portions 346A, 346B, and 346C of a cup carrier 340. Thus, when one of the groupings 342A-K of cup carriers 340 is positioned beneath the multi-cup magazine 370 with the cup receiving portions 346A, 346B, and 346C of the cup carriers 340 aligned with the second open end portions 376 of the channels 372, the released cup portions are placed on corresponding cup receiving portions 346A, 346B, and 346C of the cup carriers 340 of the one of the groupings 342A-K.

In other words, when one of the groupings 342A-K is positioned under the magazine 370, the controller 360 instructs the stop assembly 378 to release a cup portion 8 from each of the channels 372 through its second open end portion 376. The so released cup portions 8 are received by the cup receiving portions 346A, 346B, and 346C of the cup carriers 340 of the grouping under the magazine. For ease of illustration, the operations of the apparatus 300 will be described with respect to the grouping 342A. However, as is appreciated by those of ordinary skill in the art, the other groupings 342B-K are processed by the apparatus 300 in a manner identical to that of the grouping 342A.

Optionally, after releasing a cup portion 8 from each of the channels 372, the controller 360 may instruct the upper stop 377 of the stop assembly 378 to close, preventing additional cup portions 8 from exiting the channels 372 through their second open end portions 376.

Appropriate portions of the magazine 370, such as the channels 372, and the stop assembly 378 may be constructed from stainless steel or other materials known in the art as satisfying applicable USDA/FDA standards.

Turning to FIGS. 10-12, after receiving cup portions 8, the cup carriers 340 of the grouping 342A are carried by the conveyor 320 to the liquid coating station 312. As may best be viewed in FIGS. 10, 11, and 15, the liquid coating station 312 includes a first transfer mechanism 380A having an elongated member 382 with a plurality of gripping devices 384, such as vacuum manifolds, each configured to grip a single inverted cup portion 8. In embodiments in which each of the gripping devices 384 is a vacuum manifold, each of the vacuum manifolds may be coupled by a connector 385 to the vacuum source 350.

By way of a non-limiting example, the elongated member 382 may have an interior vacuum compartment (not shown) coupled to the vacuum source 350 by a connector 383A. A plurality of connectors 383B may also be in communication with the interior vacuum compartment of the elongated member 382. Each of the connectors 385 may be coupled (e.g., by a vacuum hose) one of the connectors 383B to receive suction from the interior vacuum compartment of the elongated member 382.

The elongated member 382 is movably mounted by a carrier assembly 387 to a transverse member 386 above a heated tray 211. The transverse member 386 is transverse to the conveyor 320 and extends between the conveyor and the heated tray 211. The carrier assembly 387 is configured to travel along the transverse member 386 between the conveyor 320 and the heated tray 211. The carrier assembly 387 is further configured to raise and lower the elongated member 382 relative to the conveyor 320 and the heated tray 211. The carrier assembly 387 is coupled to the controller 360, which directs the movement of the carrier assembly 387 along the transverse member 386. The controller 360 also directs the carrier assembly 387 to raise and lower the elongated member 382 relative to the conveyor 320 and the heated tray 211.

One or more sensors 356, such as air flow sensors, pressure sensors, a combination thereof, and the like, are in communication with the interior vacuum compartment of the elongated member 382. Each of the sensors 356 are coupled to the controller 360. The sensors 356 are used to detect air flow through the through holes 354 from the hollow interior portion 348 of the cup receiving portions 346A, 346B, and 346C of the cup carriers 340 of the grouping 342A indicating at least one of the cup carriers 340 of the grouping 342A is missing (or did not receive) a cup portion 8. Each of the sensors 356 is configured to send an air flow signal based on the air flow detected thereby to the controller 360. The air flow signal may be used detect air flow into the cup receiving portions 346A, 346B, and 346C of at least one of the cup carriers 340 of the grouping 342A. The controller 360 uses the signals to determine at least one of the cup carriers 340 of the grouping 342A is missing one or more cup portions 8.

If one or more of the cup carriers 340 of the grouping 342A is missing a cup portion 8, the controller 360 may decide not to process the grouping 342A. For example, the controller 360 may instruct the first transfer mechanism 380A to release any inverted cup portions 8 gripped by the gripping devices 384 and alert the operator of the apparatus 300 that a problem has occurred allowing the operator to place a cup portion on the appropriate cup carrier. Alternatively, the controller 360 may instruct the first transfer mechanism 380A to release any inverted cup portions 8 gripped by the gripping devices 384, and allow the grouping 342A to bypass the liquid coating station 312. Further, the controller 360 may cause the grouping 342A to bypass the crystal coating station 314. Then, at the packaging station 316, the uncoated cup portions may be removed manually from the cup carriers 340 and returned to the de-nesting station 310.

Turning to FIG. 16, the heated tray 211 houses the heated flavored mixture used to form the flavored layer 100 (see FIG. 5). Optionally, the heated tray 211 may include an agitation mechanism (not shown) used to agitate or stir the heated flavored mixture inside the tray. The heated tray 211 is heated by one or more heating elements 392. In the embodiment depicted, the heated tray 211 is supported by a frame 393. The heating elements 392 are mounted to the frame 393 under the heated tray 211. The heated tray 211 is coupled to the frame 393 by one or more fasteners 394.

Returning to FIGS. 10, 11, and 15, the elongated member 382 is positioned above the conveyor 320 and lowered by the carrier assembly 387 to bring the gripping devices 384 into engagement with the cup portions 8 mounted on the cup carriers 340 (see FIG. 13) of the grouping 342A (see FIG. 12). Then, the elongated member 382 is raised by the carrier assembly 387 to lift the gripping devices 384 and cup portions 8 engaged therewith from the cup receiving portions 346A, 346B, and 346C of the cup carriers 340 of the grouping 342A. Next, the carrier assembly 387 traverses the transverse member 386 and positions the elongated member 382 above the heated tray 211. Then, the elongated member 382 is lowered by the carrier assembly 387 to dip the rim portions 12 of the cup portions 8 in the heated flavored mixture residing in the heated tray 211.

After dipping, the elongated member 382 is raised by the carrier assembly 387 to remove the rim portions 12 of the cup portions 8 from the heated flavored mixture and suspended them over the heated tray 211 to allow excess heated flavored mixture disposed on the rim portions to drip therefrom back into the heated tray 211. By way of a non-limiting example, the cup portions 8 may be suspended over the heated tray 211 for about 2 seconds. As the cup portions 8 are suspended over the heated tray 211, the heated flavored mixture on the rim portions 12 begins to cool and at least partially crystallize. Next, the carrier assembly 387 traverses the transverse member 386 and positions the elongated member 382 above the conveyor 320. Then, the elongated member 382 is lowered by the carrier assembly 387 to place the cup portions 8 back on the cup receiving portions 346A, 346B, and 346C of the cup carriers 340 of the grouping 342A. Then, the gripping devices 384 of the elongated member 382 release the cup portions 8 and the elongated member 382 is raised by the carrier assembly 387 to a position above the cup carriers 340 of the grouping 342A allowing the cup carriers 340 of the grouping 342A to be transported by the conveyor 320 to the crystal coating station 314.

In other words, at the liquid coating station 312, the cup portions 8 are lifted from the cup receiving portions 346A, 346B, and 346C by the gripping devices 384 of the first transfer mechanism 380A and dipped in the heated flavored mixture residing in the heated tray 211. Then, the cup portions 8 are suspended over the heated tray 211 for about 2 seconds to allow excess flavored mixture to drip therefrom and partially cool. Then, the gripping devices 384 place the cup portions 8 back on the cup carriers 340 from which they were lifted by the gripping devices 384. After being dipped in the heated flavored mixture residing in the heated tray 211 and returned to the cup receiving portions 346A, 346B, and 346C of the cup carriers 340 of the grouping 342A, the cup portions 8 are carried by the conveyor 320 to the crystal coating station 314.

The crystal coating station 314 includes a second transfer mechanism 380B substantially similar to the first transfer mechanism 380A. However, the sensors 356 may be omitted from the second transfer mechanism 380B. For ease of illustration, like components of the first and second transfer mechanisms 380A and 380B have been identified with like reference numerals. As mentioned above, in particular embodiments, if one of the cup carriers 340 of the grouping 342A is missing a cup portion 8, the controller 360 may cause the grouping 342A to bypass the crystal coating station 314. Thus, the controller 360 may direct the second transfer mechanism 380B not to move into position above the conveyor 320 to engage with the cup portions 8.

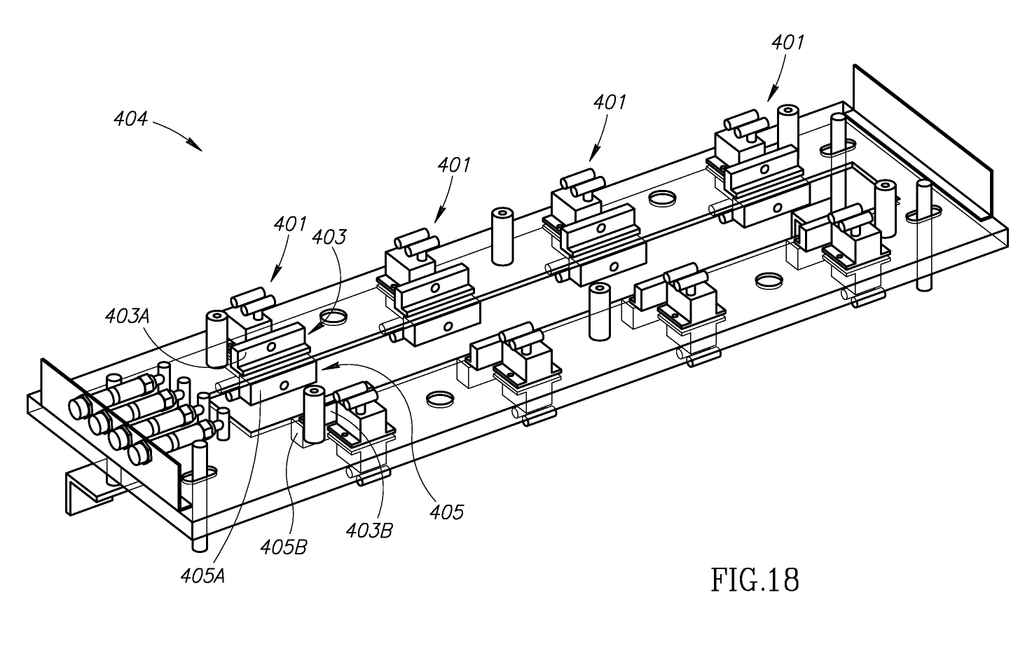

Referring to FIG. 17, the crystal coating station 314 also includes the tray 221 that houses the sugar crystals and optional acid crystals used to form the crystal layer 102 (see FIG. 5). The crystal coating station 314 includes one or more agitation assemblies 396 that agitate the crystals preventing them from aggregating together to form clumps. In the embodiment depicted, a frame 397 supports the tray 221. The tray 221 is coupled to the frame 393 by one or more mounting assemblies 394. In the embodiment depicted, the agitation assemblies 396 may be coupled to and powered by a pulse oscillator 398 supported by the frame 397.

Returning to FIGS. 10, 11, and 15, if none of the cup carriers 340 of the grouping 342A are missing a cup portion 8, the elongated member 382 of the second transfer mechanism 380B is positioned above the conveyor 320 and lowered by the carrier assembly 387 to bring the gripping devices 384 into engagement with the cup portions 8. Then, the elongated member 382 is raised by the carrier assembly 387 to lift the gripping devices 384 and the cup portions 8 engaged therewith from the cup receiving portions 346A, 346B, and 346C of the cup carriers 340 of the grouping 342A. Next, the carrier assembly 387 traverses the transverse member 386 and positions the elongated member 382 above the tray 221. Then, the elongated member 382 is lowered by the carrier assembly 387 to dip the rim portions 12 of the cup portions 8 in the sugar crystals and optional acid crystals in the tray 221. After dipping, the elongated member 382 is raised by the carrier assembly 387 to remove the rim portions 12 of the cup portions 8 from the sugar crystals and optional acid crystals. Optionally, the cup portions 8 may be suspended over the tray 221 to allow excess crystals disposed on the rim portions 12 of the cup portions 8 to fall back into the tray 221. Next, the carrier assembly 387 traverses the transverse member 386 and positions the elongated member 382 above the conveyor 320. Then, the elongated member 382 is lowered by the carrier assembly 387 to place the cup portions 8 back on the cup receiving portions 346A, 346B, and 346C of the cup carriers 340 of the grouping 342A. The gripping devices 384 of the elongated member 382 release the cup portions 8 and the elongated member 382 is raised by the carrier assembly 387 to a position above the cup carriers 340 of the grouping 342A allowing the cup carriers 340 of the grouping 342A to be transported by the conveyor 320 to the packaging station 316.

In other words, at the crystal coating station 314, the cup portions 8 are lifted by the gripping devices 384 of a second transfer mechanism 380B from the cup receiving portions 346A, 346B, and 346C of the cup carriers 340 of the grouping 342A, positioned over the tray 221, and dipped in the sugar crystals and optional acid crystals residing in a tray 221. Then, the gripping devices 384 place the cup portions 8 back on the cup carriers 340 from which they were lifted.

After being dipped in the crystals residing in the tray 221 and returned to the cup receiving portions 346A, 346B, and 346C of the cup carriers 340 of the grouping 342A, the candy coating 14 has been formed on each of the rim portions 12 of the cup portions 8 thereby constructing a plurality of the cups “A-1.” Next, the cups “A-1” are carried by the conveyor 320 to the packaging station 316.

At the packaging station 316, the cups “A-1” are packaged for sale, distribution, and/or shipment to the user. As mentioned above, the packaging station 316 may have two stages connected by the packaging conveyor 334. The first stage 330 includes a packaging magazine 400 that places trays “B” on the packaging conveyor 334. The packaging magazine 400 may be substantially similar to the magazine 370. However, instead of being configured to receive a plurality of stacks 373 of inverted cup portions 8, the packaging magazine 400 is configure to receive a plurality of stacks (not shown) of upright trays “B.” Like the magazine 370, the packaging magazine 400 includes a plurality of channels 402 each housing a stack of trays (not shown) and a stop mechanism 404 configured to place a single tray “B” from each stack on the packaging conveyor 334.

The packaging conveyor 334 includes a stationary trough (not shown) disposed between a pair of spaced apart movable drive chains (not shown). A plurality of movable pushing members (not shown) extend laterally between and are driven by the spaced apart drive chains. The pushing members are moved longitudinally relative to the trough. The pushing members are spaced longitudinally far enough apart to allow a tray “B” to be received between each adjacent pair of pushing members. The pushing members push the trays “B” through the trough. Beneath each of the channels 402 of the packaging magazine 400, the trough includes one or more through-holes.

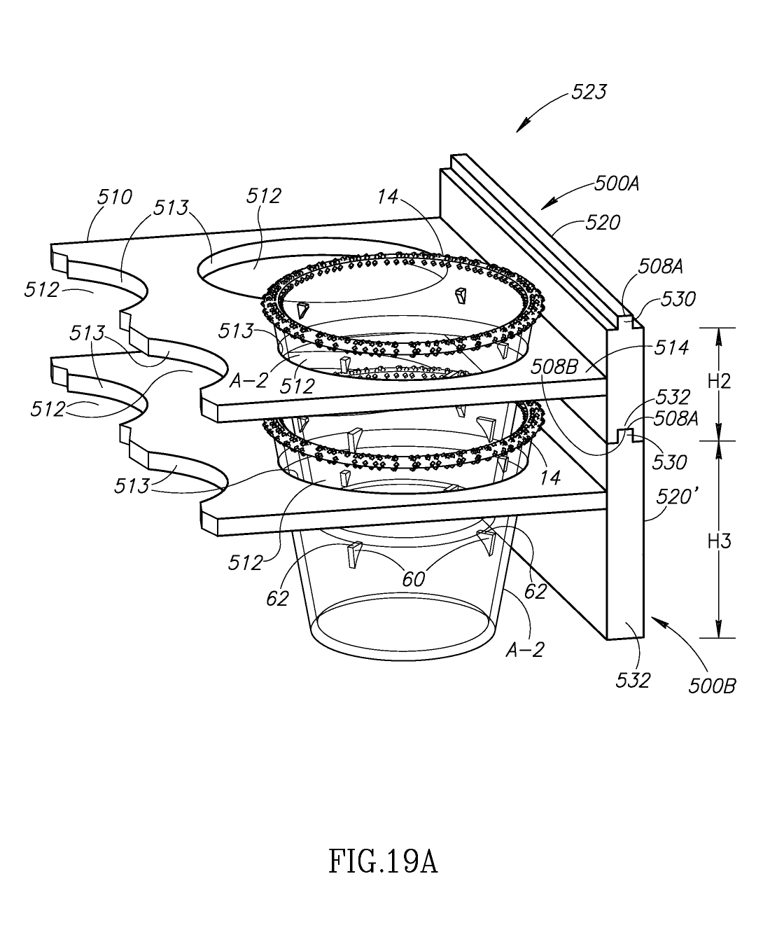

Referring to FIG. 18, the stop mechanism 404 may include one or more stop assemblies 401 each substantially similar to the stop assembly 378 of the magazine 370. Each stop assemblies 401 may be adjacent one of the plurality of channels 402. In the embodiment illustrated, the stop assembly 401 includes an upper stop 403 above a lower stop 405.

The upper stop 403 includes a first stop portion 403A juxtaposed across from a second stop portion 403B. The first and second stop portions 403A and 403B function in the substantially the same manner as the first and second stop portions 377A and 377B (see FIG. 14), respectively, of the upper stop 377 of the magazine 370.

The lower stop 405 includes a first stop portion 405A juxtaposed across from a second stop portion 405B. The first and second stop portions 405A and 405B function in the substantially the same manner as the first and second stop portions 379A and 379B (see FIG. 14), respectively, of the lower stop 379 of the magazine 370.

At least one moveable suction cup assembly (not shown) is located opposite the packaging magazine 400 below the stationary trough (not shown). The suction cup assembly includes one or more gripping members, such as suction cups, vacuum manifolds, and the like, for each of the plurality of channels 402. The gripping members are mounted on a guide track and travel vertically from beneath the trough up through the one or more through-holes formed therein to a position above the trough.

By way of a non-limiting example, the suction cup assembly may include a pair of guide tracks each having two pairs of movable gripping members. On each guide track, the pairs of movable gripping members are spaced apart from one another and are configured to move along the guide track together at the same time. Further, the gripping members of both guide tracks are configured to move together at the same time. In this manner, a pair of gripping members is provided for each channels 402 of the packaging magazine 400 and configured to grip a single tray “B” (previously released by each of the channels 402) at the same time. Each pair of gripping members may travel from beneath the trough to a position above the trough through a corresponding one of the through-holes formed in the trough.

During operation, a bottom most tray “B” of each of the stacks of upright trays residing in the channels 402 rests upon the closed upper stop 403 of one of the stop assemblies 401. Before the upper stop 403 is opened, the lower stop 405 is closed. Then, the first and second stop portions 403A and 403B are opened, and the bottom most tray “B” passes through the upper stop 403 and is stopped by the closed lower stop 405. Next, each pair of gripping members is raised to grip the bottom most tray “B” resting on the first and second stop portions 405A and 405B of the closed lower stop 405. As the first and second stop portions 405A and 405B are opened, each pair of gripping members may be lowered (along the guide tracks) to pull the gripped tray “B” downwardly onto the stationary trough of the packaging conveyor 334. After the lower stop 405 is opened, the bottom most tray “B” is released by the stop assembly 401 and placed on the trough of the packaging conveyor 334. To prevent a second tray “B” from passing through the open upper stop 403, the upper stop 403 is closed as the lower stop 405 is opened.

If the number of cups “A-1” held by each tray “B” is the same as the number of cups “A-1” held by a cup carrier 340, the number of trays “B” placed on the packaging conveyor 334 by the packaging magazine 400 may be the same as the number of cup carriers 340 in the grouping 342A. The pushing members of the packaging conveyor 334 push the trays “B” placed on the trough to the second stage 332.

The second stage 332 includes a third transfer mechanism 380C substantially similar to the first transfer mechanism 380A. However, the sensors 356 may be omitted from the third transfer mechanism 380C. For ease of illustration, like components of the first and third transfer mechanisms 380A and 380C have been identified with like reference numerals. As mentioned above, in particular embodiments, if one of the cup carriers 340 of the grouping 342A is missing a cup portion 8, the controller 360 may cause the grouping 342A to bypass the packaging station 316. Thus, the controller 360 may direct the third transfer mechanism 380C not to move into position above the conveyor 320 to engage with the cup portions 8.

On the other hand, if none of the cup carriers 340 of the grouping 342A are missing a cup portion 8, the elongated member 382 of the third transfer mechanism 380C is positioned above the conveyor 320 and lowered by the carrier assembly 387 to bring the gripping devices 384 into engagement with the cup portions 8. Then, the elongated member 382 is raised by the carrier assembly 387 to lift the gripping devices 384 and cup portions 8 engaged therewith from the cup receiving portions 346A, 346B, and 346C of the cup carriers 340 of the grouping 342A. Next, the carrier assembly 387 traverses the transverse member 386 and positions the elongated member 382 above the trays “B” on the packaging conveyor 334. Then, the elongated member 382 is lowered by the carrier assembly 387 to place the cup portions 8 on the bosses 18 of the trays “B” disposed on the packaging conveyor 334. Next, the gripping devices 384 of the elongated member 382 release the cups “A-1” and the elongated member 382 is raised by the carrier assembly 387. Then, the carrier assembly 387 traverses the transverse member 386 and positions the elongated member 382 above the conveyor 320.

In other words, the cup portions 8 are lifted by gripping devices 384 of a third transfer mechanism 380C from the cup receiving portions 346A, 346B, and 346C of the cup carriers 340 of the grouping 342A, positioned over the trays “B”, and placed on the bosses 18 of the trays “B.” Then, the trays “B” loaded with cups “A-1” are removed from the packaging conveyor 334 and placed in boxes (not shown). By way of a non-limiting example, the trays “B” may be placed in boxes (not shown) manually and the boxes subsequently shrink wrapped.

As may best be viewed in FIG. 12, the cup carriers 340 of the grouping 342A travel along the closed loop conveyor 320 and return to the de-nesting station 310.

Alternate Embodiments of Packaging

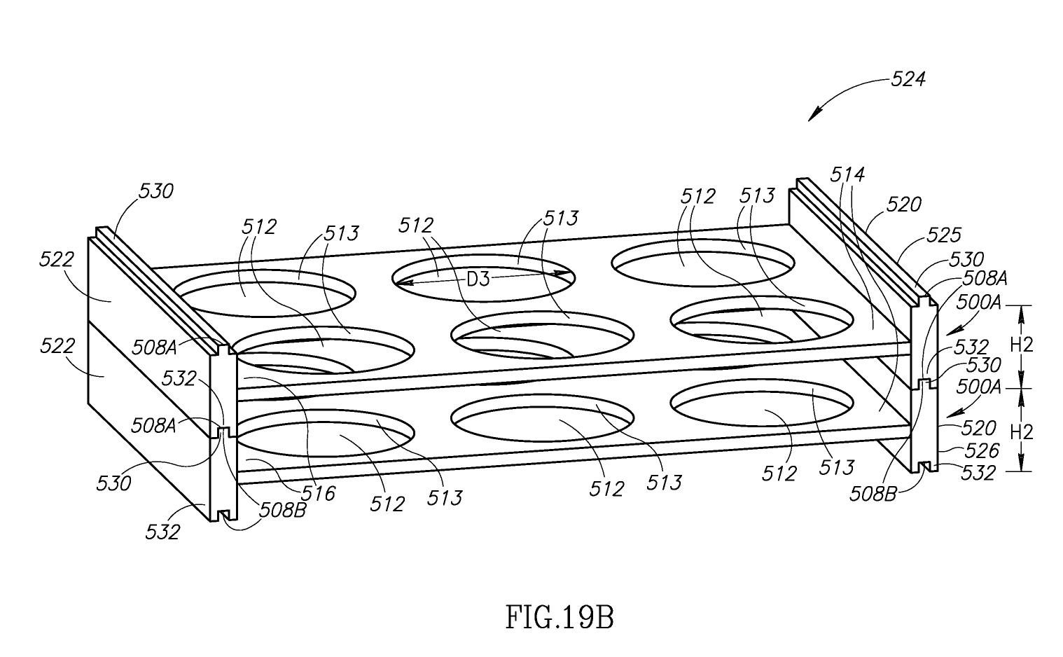

Referring to FIGS. 19A and 19B, a tray 500A is provided. The tray 500A may be used with a cup “A-2” having the cup portion 8 and the candy coating 14. The tray 500A includes a cup receiving member 510 having a plurality of spaced apart cup receiving apertures 512 defined by a sidewall 513. In the embodiment depicted, the cup receiving member 510 is generally plate shaped, horizontal, and planar, and includes six cup receiving apertures 512. However, this is not a requirement. Each of the cup receiving apertures 512 has a diameter “D3” and is configured to receive a single cup “A-2” in an upright orientation. The cups “A-2” may be stored, shipped, or otherwise distributed in one or more trays 500A. The diameter “D3” determines at which point along the sidewall 10 the sidewall 513 of one of the cup receiving apertures 512 contacts the cup portion 8 when a cup “A-2” is received in the cup receiving aperture 512.

The cup receiving member 510 has a first end portion 514 opposite a second end portion 516. The tray 500A is supported at its first end portion 514 by a first upright support member 520 and at its second end portion 516 by a second upright support member 522. Optionally, the first and second upright support members 520 and 522 may each include a plurality of reinforcement ribs (not shown) to increase the rigidity of the first and second upright support members 520 and 522.

In the embodiment implemented in FIGS. 19A and 19B, the tray 500A is configured to stack upon another like tray to form a stack. The stack 524 illustrated in FIG. 19B includes an upper tray 525 stacked upon a lower tray 526. As is apparent to those of ordinary skill in the art, the stack 524 may include one or more additional trays 500A (not shown) stacked upon the upper tray 525. A stack 523 illustrated in FIG. 19A includes a tray 500A stacked upon a base tray 500B (described below). As is apparent to those of ordinary skill in the art, the stack 523 may include one or more trays 500A (not shown) stacked upon the tray 500A.

Referring to FIG. 19B, each of the first and second upright support members 520 and 522 may have an upper portion 530 opposite a lower portion 532. The upper portions 530 of the first and second upright support members 520 and 522 of the lower tray 526 may be coupled to the lower portions 532 of the first and second upright support members 520 and 522 of the upper tray 525, respectively, to prevent movement of the upper tray and lower trays relative to one another and help maintain them in the stacked arrangement of the stack 524. By way of a non-limiting example, the upper portions 530 of the first and second upright support members 520 and 522 may include one of a key portion 508A and a keyway portion 508B. For example, the key portion 508A may be a tongue member and the keyway portion 508B may be a groove of a conventional tongue and groove joint. In such an embodiment, the lower portions 532 of the first and second upright support members 520 and 522 include the other of the key portion (not shown) and the keyway portion (not shown).

How far the candy coatings 14 of the cups “A-2” residing in the cup receiving apertures 512 of the lower tray 526 are spaced from the bottom portions 9 of the cups “A-2” residing in the cup receiving apertures 512 of the upper tray 525 may be determined at least in part by a height “H2” of the first and second upright support members 520 and 522. In the embodiment illustrated in FIG. 19A, the bottom portion 9 of the cup “A-2” in the tray 500A rests upon and is supported by the support projections 60 of the cup “A-2” in the base tray 500B. Similarly, in FIG. 19B, the bottom portion 9 of a cup “A-2” in the upper tray 525 would rest upon and be supported by the support projections 60 of a cup “A-2” in the lower tray 526.

Referring to FIG. 19A, the base tray 500B is substantially similar to the tray 500A. Therefore, like reference numerals have been used to identify like components of the tray 500A and the base tray 500B. However, the base tray 500B includes a first upright support member 520′ and a second upright support member (not shown) instead of the first and second upright support members 520 and 522. The first and second upright support members of the base tray 500B may differ from the first and second upright support members 520 and 522 of the tray 500A with respect to their height “H3.” In the embodiment illustrated, the height “H3” of the first and second upright support members of the base tray 500B may be greater than the height “H2” of the first and second upright support members 520 and 522 of the tray 500A to allow the first and second upright support members of the base tray 500B to extend to at least the bottom portions 9 of the cups “A-2” in the base tray 500B so that the first and second upright support members of the base tray 500B may rest upon a support surface (not shown). When the first and second upright support members of the base tray 500B are resting upon the support surface, the bottom portion 9 is either resting upon or supported above the same support surface.

In the embodiment illustrated in FIG. 19A, the height “H3” of the first and second upright support members of the base tray 500B is adequate to allow the first and second upright support members of the base tray 500B to extend past the bottom portions 9 of the cups “A-2” in the base tray 500B and allow the stack 523 to be supported above a support surface (not shown). Further, optionally, the key portion 508A and/or the keyway portion 508B may be omitted from the lower portions 532 of the first and second upright support members of the base tray 500B.

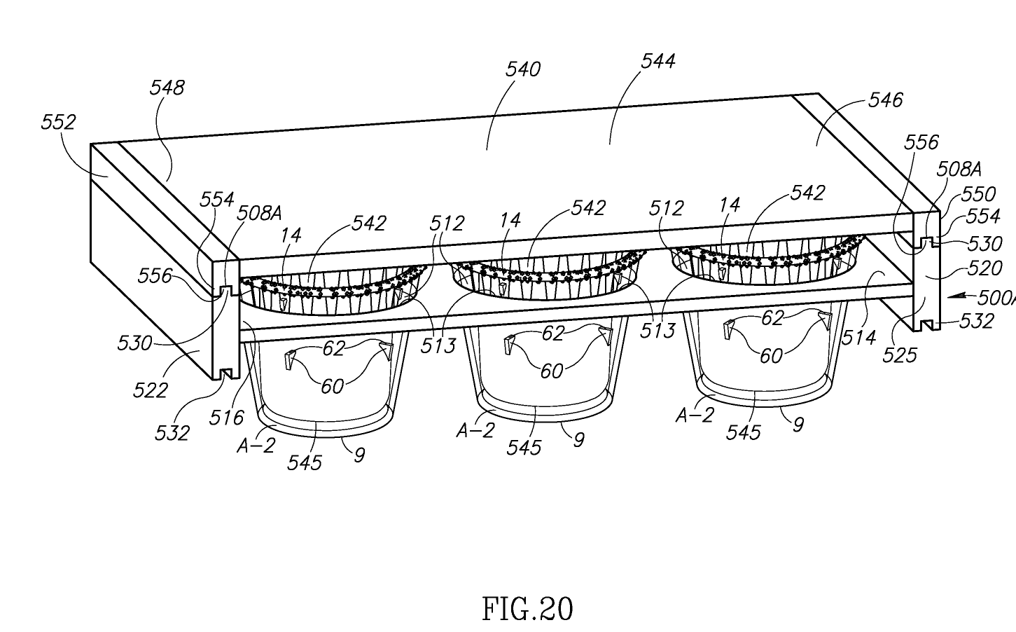

Referring to FIG. 20, a top cap or lid 540 may be secured to the upper portions 530 of the first and second upright support members 520 and 522 of the upper tray 525 and used to maintain any cups “A-2” residing in the cup receiving apertures 512 of the upper tray 525 therein. The lid 540 includes a plurality of bosses 542 that project outwardly from an upper member 544. Each of the bosses 542 may be substantially similar to the bosses 18 (described above and illustrated in FIGS. 6-8). The plurality of bosses 542 are arranged to extend downwardly from the upper member 544 and into the cups “A-2” residing in the cup receiving apertures 512 of the upper tray 525. In the embodiment illustrated, the bosses 542 include a closed end portion 545 that abuts the bottom portion 9 of the cups “A-2.” However, referring to FIG. 3, the closed end portion 545 may abut one of the upper portion 62 of the inwardly extending support projections 60 instead of the bottom portion 9. Referring to FIG. 4, if the cups “A-3” reside in the upper tray 525, instead of the cups “A-2,” the closed end portion 545 may abut the support portion 92 instead of the bottom portion 9.

In the embodiment depicted, the upper member 544 of the lid 540 has a first end portion 546 opposite a second end portion 548. The tray 500A is supported at its first end portion 546 by a first upright support member 550 and at its second end portion 548 by a second upright support member 552. Each of the first and second upright support members 550 and 552 may have a lower portion 554. The lower portions 554 of the first and second upright support members 550 and 552 may be coupled to the upper portions 530 of the first and second upright support members 520 and 522, respectively. By way of a non-limiting example, the upper portions 530 of the first and second upright support members 520 and 522 of the upper tray 525 may include the key portion 508A. In such an embodiment, the lower portions 554 of the first and second upright support members 550 and 552 of the lid 540 include the other of a keyway portion 556 substantially similar to the keyway portion 508B (see FIG. 19A).

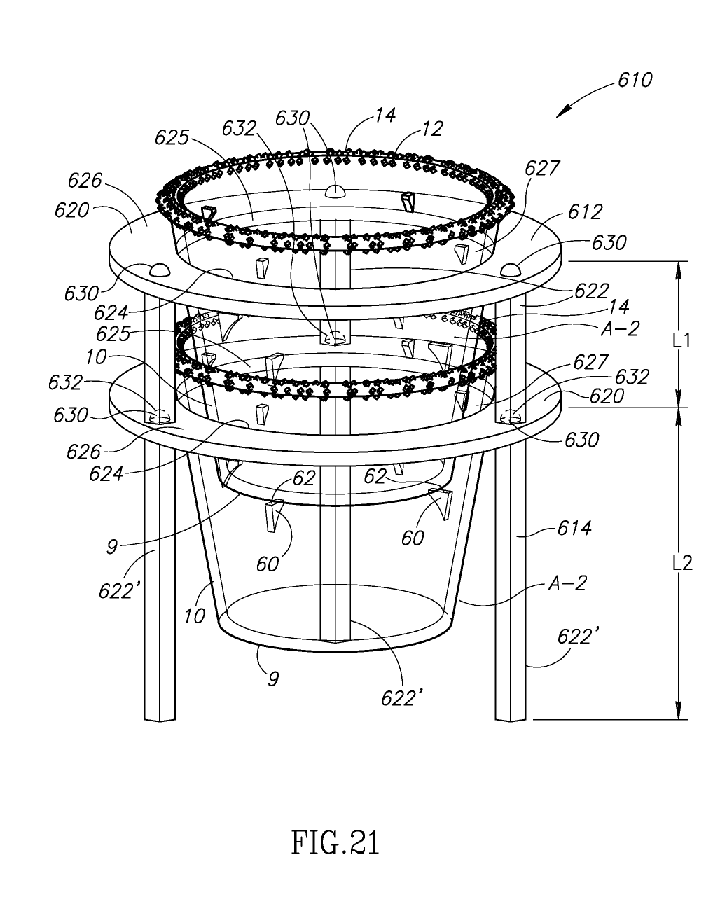

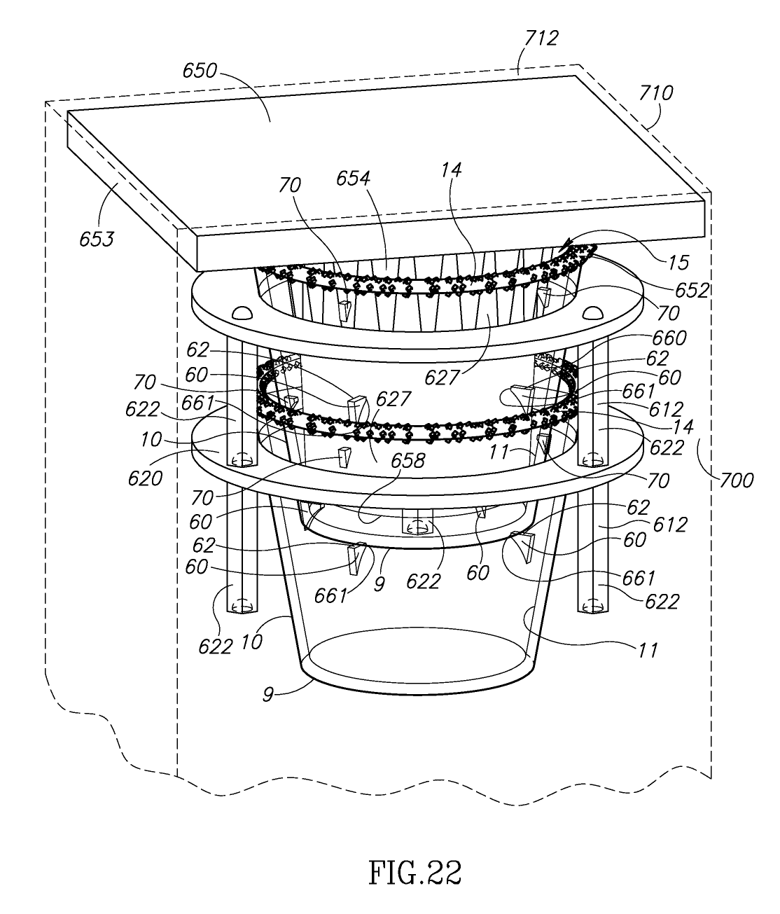

FIG. 21 provides an upper stacking support member 612 supported by a base stacking support member 614 that together may be used to create a stack 610 of any of the cups described above. The upper stacking support member 612 may be used with any conventional drinking cup or similar vessel known in the art. For illustrative purposes, the upper stacking support member 612 is illustrated in use with the cups “A-2.” Referring to FIG. 22, any number of like upper stacking support members 612 may be stacked one upon another to increase the height of the stack 610.

Returning to FIG. 21, the upper stacking support member 612 includes a deck or support platform 620 supported by a plurality of upright support legs 622. The support platform 620 includes a cup receiving aperture 624 defined by a sidewall 625 and configured to receive a single upright cup “A-2.” The cup receiving aperture 624 is spaced inwardly from the upright support legs 622, which are disposed about the cup receiving aperture 624. The size of the cup receiving aperture 624 determines at which point along the sidewall 10 of the cup portion 58 the sidewall 625 of the cup receiving aperture 624 engages the sidewall 10. The cup receiving aperture 624 is sized and shaped to provide a gripping portion 627 above the support platform 620. The gripping portion 627 may be substantially similar to the gripping portion 64 (see FIGS. 3 and 4), discussed above. The support platform 620 has an upper surface 626 with a plurality of upwardly extending projections 630. Each of the upright support legs 622 includes a recess 632 configured to receive one of the upwardly extending projections 630.

The base stacking support member 614 is substantially similar to the upper stacking support member 612. Therefore, like reference numerals have been used to identify like components of the base stacking support member 614 and the upper stacking support member 612. However, as will be described below, the upright support legs 622′ of the base stacking support member 614 differ from the upright support legs 622 of the upper stacking support member 612.

Within the bottom portion of the stack 610, the plurality of upright support legs 622 of the upper stacking support member 612 rest upon and are supported by the support platform 620 of the base stacking support member 614. Within other portions of the stack 610, the plurality of upright support legs 622 of the upper stacking support member 612 rest upon and are supported by the support platform 620 of a like upper stacking support member 612.

The upwardly extending projections 630 of the base stacking support member 614 are arranged to be positionable within the recesses 632 of the upright support legs 622 of the upper stacking support member 612, when the upper stacking support member 612 is stacked upon the base stacking support member 614. The upwardly extending projections 630 and the recesses 632 may be configured to snap together to form a snap fit arrangement. Once inside the recesses 632, the upwardly extending projections 630 of the lower stacking support member 614 help prevent lateral movement of the upper stacking support member 612 and the base stacking support member 614 relative to one another, thereby helping to maintain the upper and lower cups in the stacked arrangement.

Similarly, the upwardly extending projections 630 of the upper stacking support member 612 are arranged to be positionable within the recesses 632 of the upright support legs 622 of a like upper stacking support member, when the like upper stacking support member is stacked upon the upper stacking support member 612. Once inside the recesses 632, the upwardly extending projections 630 of the upper stacking support member 614 help prevent lateral movement of the like upper stacking support member relative to the upper stacking support member 612, thereby helping to maintain the cups in the stacked arrangement.

How far the candy coating 14 of the cup “A-2” residing in the cup receiving aperture 624 of the base stacking support member 614 is spaced from the bottom portion 9 of the cup “A-2” residing in the cup receiving aperture 624 of the upper stacking support member 612 may be determined at least in part by a length “L1” of the upright support legs 622 In the embodiment illustrated, the bottom portion 9 of the cup “A-2” in the upper stacking support member 612 rests upon and is supported by the support projections 60 of the cup “A-2” in the base stacking support member 614.

The upright support legs 622′ of the base stacking support member 614 differ from the upright support legs 622 of the upper stacking support member 612. For example, the length “L2” of the upright support legs 622′ may be greater than the length “L1” of the upright support legs 622 to allow the upright support legs 622′ to extend from the support platform 620 of the base stacking support member 614 to at least the bottom portion 9 of the bottom cup “A-2” in the stack 610 so that the upright support legs 622′ may rest upon a support surface (not shown). When the upright support legs 622′ are resting upon the support surface, the bottom portion 9 is either resting upon or supported above the same support surface. In the embodiment illustrated in FIG. 21, the length “L2” of the upright support legs 622′ is adequate to allow the upright support legs 622′ to extend past the bottom portion 9 of the bottom cup “A-2” in the stack 610 and allow the stack 610 to be supported above a support surface (not shown). Further, optionally, the recesses 632 may be omitted from the upright support legs 622′.

Conventional plastic cups are arranged in stacks and placed inside an external packaging, such as a tube shaped plastic bag, elongated box, and the like. The external packaging is typically sealed to retain the stack inside. The external packaging defines a closed packaging envelope in which the stack(s) of cups are housed. The packaging envelope limits the longitudinal movement of the cups within the stack. Thus, the degree to which the cups in a conventional stack may become unstacked is determined by the packaging envelope. However, contact between the inside surfaces of the external packaging and the candy coatings 14 of the cups “A-1,” “A-2,” and “A-3” could result in damage to the candy coatings.

FIGS. 22-24 depict a cap 650, which may be disposed at one end of a stack of cups “A-1,” “A-2,” and “A-3” and the like. The cap 650 is positionable between an end cup 652 (at one end of the stack) and an interior surface 700 of external packaging 710 (illustrated in FIG. 22) at one of its sealed ends 712, such as a closed or sealed end of a tube-shaped bag (not shown) or box adjacent the end cup. Thus, the cap 650 contacts the inside surface 700 of the sealed end 712 of the external packaging 710 instead of the candy coating 14 of the end cup 652. The cap 650 includes a spacer portion 653 and a boss 654 substantially similar to one of the bosses 18 (see FIGS. 6-8) extending away from the spacer portion 653. The spacer portion 653 bears against or abuts the inside surface 700 of the external packaging 710 and spaces the candy coatings 14 of one or more of the cups in a stack from the inside surface 700 of the external packaging 710.

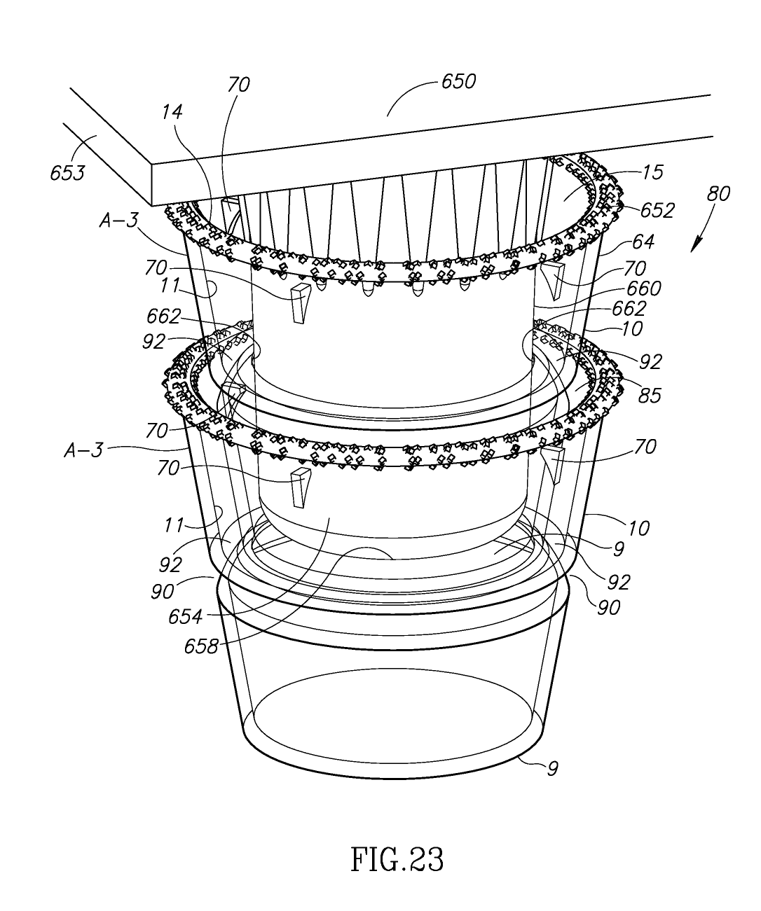

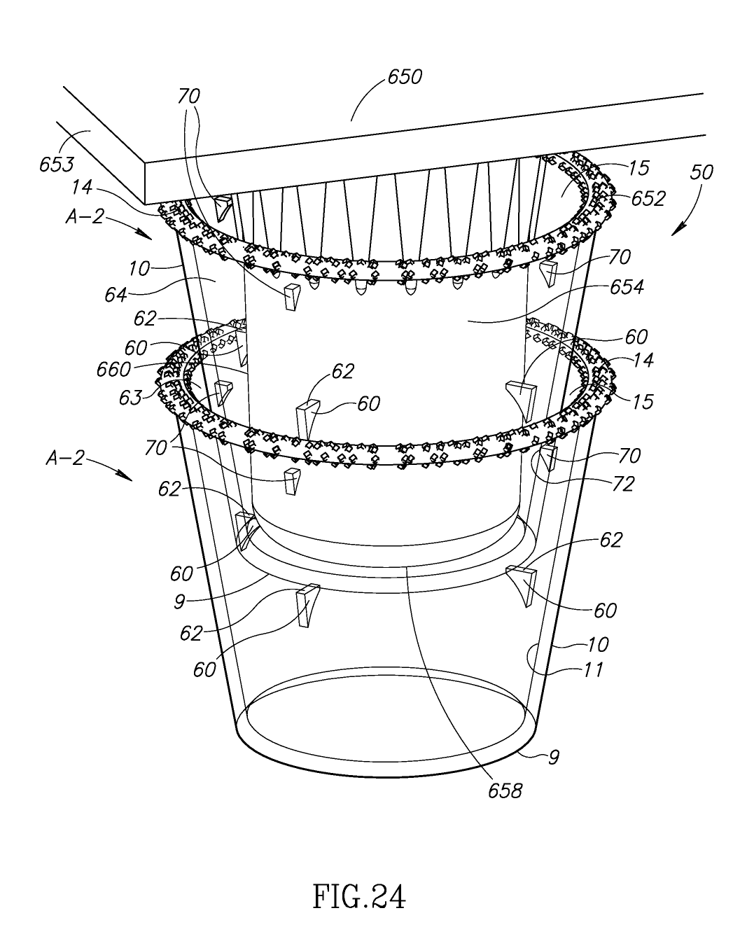

The boss 654 includes a closed end portion 658 and a sidewall 660. The boss 654 extends into the interior portion 15 of the end cup 652. In the embodiment illustrated in FIG. 24, the closed end portion 658 of the boss 654 abuts the bottom portion 9 of the cup “A-2.” Alternatively, the sidewall 660 may abut a portion 661 (see FIG. 22) of the support projections 60 instead of the bottom portion 9. By way of another non-limiting example, the closed end portion 658 may abut the upper portion 62 of the inwardly extending support projections 60 instead of the bottom portion 9. By way of yet another non-limiting example, as illustrated in FIG. 23, the sidewall 660 may abut a portion 662 of the inside surface 11 adjacent the narrowed portion 90 formed in the sidewall 10 between the bottom portion 9 and the spacer projections 70. By way of yet another non-limiting example, the closed end portion 658 may abut the support portion 92 instead of the portion 662 of the inside surface 11. By way of yet another non-limiting example, the closed end portion 658 may abut the bottom portion 9 of the cup “A-3.”

The external packaging 710 may be appropriately sized and shaped to avoid damage to the candy coatings 14 of the cups in the stack. Further, more than one stack may be placed inside the external packaging 710 and embodiments in which the cap 650 includes more than one boss 654 (one for each stack) are within the scope of the present teachings. A second cap (not shown) or similar positioning device may be used to maintain the position of cup at the opposite end of the stack from the end cup 652 relative to the stack, and/or external packaging 710.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

1.-12. (canceled)

13. A cup for use by a user, the cup comprising:
a cup portion having a bottom portion, a sidewall with a rim portion, an interior portion defined by the sidewall and the bottom portion, and at least one support projection extending radially inward into the interior portion, the at least one support projection being configured to abut a bottom portion of a like cup insertable into the interior portion of the cup portion, and to limit a depth of insertion of the insertable like cup into the interior portion of the cup portion thereby exposing a gripping portion of the insertable like cup above the rim portion of the cup portion of the cup,
the gripping portion of the insertable like cup being large enough to be gripped by the user without contacting the rim portion of either the cup or the like cup.

14. The cup of claim 13, wherein the gripping portion of the insertable like cup extends approximately one inch to approximately 1.25 inches above the rim portion of the cup.

15. The cup of claim 13, wherein the at least one support projection comprises a plurality of circumferentially spaced apart support projections each comprising an abutting portion configured to abut and support the bottom portion of the insertable like cup.

16. The cup of claim 13, wherein the cup portion further comprises a plurality of spacer projections extending radially inward into the interior portion of the cup portion of the cup, the plurality of spacer projections being located between the rim portion and the at least one support projection, the plurality of spacer projections contacting the sidewall of the cup portion of the like cup thereby spacing the rim portion of the cup from the sidewall of the like cup when the like cup is inserted in the interior portion of the cup.

17. The cup of claim 13 further comprising:
a coating disposed about the rim portion wherein the gripping portion of the insertable like cup is large enough to be gripped by the user without disturbing the coating on the rim portion of either the cup or the like cup.

18-24. (canceled)

25. A cap for use with a stack of cups having an end cup, each cup in the stack having a rim portion and a coating disposed on the rim portion, the coating being damageable upon contact, the cap comprising:
means for engaging external packaging defining a packaging envelope around the stack of cups; and
a projection insertable into the end cup, the projection engaging a portion of the end cup and spacing the coating disposed on the rim portion of the end cup from the means for engaging the external packaging.

26-37. (canceled)

38. A tray for storing a plurality of cups each having a rim, a bottom portion, a sidewall extending between the rim and bottom portion, and a coating disposed on the rim, the tray being stackable on a like tray, the tray comprising:
a cup receiving member having a first side portion opposite a second side portion and a plurality of spaced apart cup receiving apertures, each cup receiving aperture being configured to engage a portion of the outside of the sidewall of one of the plurality of cups at a location between the coating and the bottom portion;
a first support wall coupled to the first side portion of the cup receiving member, the first support wall having an upper edge portion opposite a lower edge portion, the upper edge portion being configured to mate with a lower edge portion of a like first support wall of a first like tray and the lower edge portion being configured to mate with an upper edge portion of a second like first support wall of a like tray; and
a second support wall coupled to the second side portion of the cup receiving member, the second support wall having an upper edge portion opposite a lower edge portion, the upper edge portion being configured to mate with a lower edge portion of a like second support wall of the first like tray and the lower edge portion being configured to mate with an upper edge portion of the like second support wall of the second like tray.

39. The tray of claim 38 for use with a plurality of cups each having an interior portion defined by the sidewall, and one or more projections extending inwardly from the sidewall into the interior portion, the one or more inwardly extending projections being configured to abut the bottom portion of a like cup insertable into the interior portion of the cup and to space the coating of the cup from the like cup, wherein the first and second support walls of the tray are each configured to position the bottom portions of the cups stored inside the plurality of spaced apart cup receiving apertures of the cup receiving member of the tray upon the one or more inwardly extending projections of cups stored inside a plurality of spaced apart cup receiving apertures of a cup receiving member of the second like tray upon which the tray is stacked.

40. The tray of claim 38 for use with a base tray having a first support wall spaced from a second support wall, each of the first and second support walls having an upper edge portion opposite a lower edge portion, the upper edge portion of the first support wall of the base tray being configured to mate with the lower edge portion of the first support wall of the tray, the upper edge portion of the second support wall of the base tray being configured to mate with the lower edge portion of the second support wall of the tray, the lower edge portion of the first and second support walls of the base tray being configured to rest upon a support surface,
wherein the tray is stackable on the base tray,
the lower edge portion of the first support wall of the tray is configured to mate with the upper edge portion of the first support wall of the base tray, and
the lower edge portion of the second support wall of the tray is configured to mate with the upper edge portion of the second support wall of the base tray.

41. A stacking support member for use with a cup having a rim, a bottom portion, a sidewall extending between the rim and bottom portion defining an interior portion, and a coating disposed on the rim, the stacking support member being stackable on a like stacking support member, the stacking support member comprising:
a cup receiving member having a cup receiving aperture configured to engage a portion of the outside of the sidewall of the cup at a location between the coating and the bottom portion;
a plurality of spaced apart upright support legs configured to support the cup receiving member and to be supportable by a cup receiving member of a like stacking support member, the plurality of upright support legs being further configured to space the bottom portion of the cup received in the cup receiving aperture inside an interior portion of a like cup receivable inside a cup receiving aperture of the cup receiving member of the like stacking support member when the cup receiving member of the like stacking support member is supporting the plurality of upright support legs.

42. The stacking support member of claim 41, wherein the cup receiving member comprises a plurality of upwardly extending projections,
each of the plurality of upright support legs comprises a recess configured to receive one of the plurality of upwardly extending projections of a like stacking support member, and
the plurality of upwardly extending projections are arranged on the cup receiving member to be receivable inside the recesses of a plurality of upright support legs of a like stacking support member supportable by the cup receiving member.
